(19) United States
(12) Patent Application Publication
(10) Pub. No.: US 2026/0067346 A1
(43) Pub. Date: Mar. 5, 2026

(54) System, Device, and Method of Video Encoding and Video Transmission Using Improved Estimation of Available Bandwidth

(71) Applicant: AMIMON LTD., Ra'anana (IL)

(72) Inventors: Dvir Olansky, Hod HaSharon (IL); Ido Atlas, Tel Aviv (IL); Zvi Reznic, Tel Aviv (IL)

(21) Appl. No.: 19/102,399

(22) PCT Filed: Aug. 14, 2023
(86) PCT No.: PCT/IL2023/050848

§ 371 Date: Feb. 9, 2025

Related U.S. Application Data
(60) Provisional application No. 63/371,669, filed on Aug. 17, 2022.

(51) Int. Cl. H04L 65/80; H04L 43/087; H04L 65/70

(52) U.S. Cl. CPC H04L 65/80; H04L 43/087; H04L 65/70

(57) ABSTRACT

System, device, and method of video encoding and video transmission using improved estimation of available bandwidth. A transmitting device is configured to transmit video data to a recipient device over a communication network having a non-fixed bandwidth. A configurable video encoder encodes a source video into an encoded video. An Available Bandwidth Estimator operates at the recipient device, to estimate a currently-available bandwidth of the communication channel. Two different bandwidth estimation methods are used at the recipient device, and one of two estimated values is then selected based on pre-defined selection rules. Video encoding parameters that are used by the configurable video encoder of the transmitting device are dynamically modified based on the most-recent estimate of the currently-available bandwidth of the communication channel. Optionally, pre-transmission packets are sorted at the transmitting device, based on packet size, to improve accuracy of bandwidth estimation.

### CROSS-REFERENCE TO RELATED APPLICATIONS

This patent applications claims priority and benefit from U.S. 63/371,669, filed on Aug. 17, 2022, which is hereby incorporated by reference in its entirety.

### FIELD

Some embodiments relate to the field of communication systems.

### BACKGROUND

Electronic devices and computing devices are utilized on a daily basis by millions of users worldwide. For example, laptop computers, desktop computers, smartphone, tablets, and other electronic devices are utilized for browsing the Internet, consuming digital content, streaming audio and video, sending and receiving electronic mail (email) messages, Instant Messaging (IM), video conferences, playing games, or the like.

Many electronic devices communicate with each other, or with remote servers or remote entities, via one or more wireless communication links or networks; for example, using Wi-Fi, using cellular communications, over the Internet, or the like. Some electronic devices are utilized to receive wireless communications signals that carry video data, to allow such electronic devices to play a streaming video or a video clip on a display unit thereof.

### SUMMARY

Some embodiments provide systems, devices, and methods of video encoding and video transmission using improved estimation of available bandwidth. For example, a transmitting device is configured to transmit video data to a recipient device over a communication network having a non-fixed bandwidth. A configurable video encoder encodes a source video into an encoded video. An Available Bandwidth Estimator operates at the recipient device, to estimate a currently-available bandwidth of the communication channel. Two different bandwidth estimation methods are used at the recipient device, and one of two estimated values is then selected based on pre-defined selection rules. Video encoding parameters that are used by the configurable video encoder of the transmitting device are dynamically modified based on the most-recent estimate of the currently-available bandwidth of the communication channel. Optionally, pre-transmission packets are sorted in a pre-transmission buffer at the transmitting device, based on packet size, to improve accuracy of bandwidth estimation.

Some embodiments may provide other and/or additional advantages and/or benefits.

### BRIEF DESCRIPTION OF THE DRAWINGS

FIG. 1 is a schematic illustration of a system, in accordance with some demonstrative embodiments.

FIG. 2 is an illustration of a chart demonstrating changes in available bandwidth and in transmission rate, in accordance with some demonstrative embodiments.

FIG. 3A is an illustration of a chart demonstrating bandwidth estimation performed on a video transmission in which all packets have uniform size, in accordance with some embodiments.

FIG. 3B is an illustration of a chart demonstrating bandwidth estimation performed on a video transmission in which some but not all packets have uniform size, in accordance with some embodiments.

FIG. 4A is an illustration of a chart demonstrating a polyfit result corresponding to the bandwidth estimation values of FIG. 3A, in accordance with some embodiments.

FIG. 4B is an illustration of a chart demonstrating a polyfit result corresponding to the bandwidth estimation values of FIG. 3B, in accordance with some embodiments.

### DETAILED DESCRIPTION OF SOME DEMONSTRATIVE EMBODIMENTS

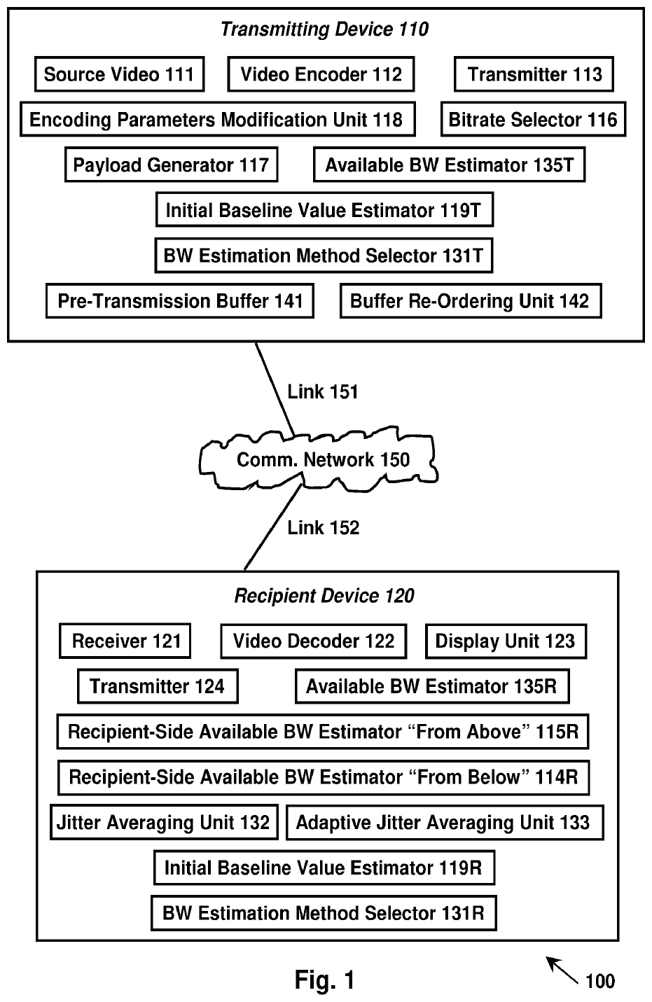

Reference is made to FIG. 1, which is a schematic illustration of a system 100, in accordance with some demonstrative embodiments. System 100 comprises a Transmitting Device 110 able to communicate with a Recipient Device 120 over a communication link (e.g., a wireless communication link; a wired communication link; a combination or chain of one or more wireless communication link(s) and/or wired communication link(s)). Such link(s) may include, for example, Wi-Fi communication link(s), cellular communication link(s), Internet-based or Internet Protocol (IP) based links, or the like.

Transmitting Device 110 stores or receives, or has access to, a Source Video 111 (or an input video, or a video payload, or a video content, or a video file, or a video stream, or a video item), which is intended to be transmitted and delivered to Recipient Device 120. In some embodiments, Source Video 111 may be a live video or a live stream of video, for example, as acquired or captured by a camera or imager or other video-acquisition device. In other embodiments, Source Video 111 may be an already-produced or already-prepared video file which is stored locally or remotely in a repository or a storage unit.

Transmitting Device 110 comprises a Video Encoder 112, which performs video encoding and/or video compression of Source Video 111, for example, using High Efficiency Video Coding (HEVC) or H.265, or using Advanced Video Coding (AVC) or H.264, or using AOMedia Video 1 (AV1) coding, or the like. The encoded or compressed video data is transmitted from a Transmitter 113 of the Transmitting Device 110, and is received by a Receiver 121 of the Recipient Device 120. There, a Video Decoder 122 performs decoding and/or decompression of the encoded or compressed video data; for example, into a format that can then be displayed by a Display Unit 123 (e.g., screen, touch-screen, monitor, television screen) which may be an integrated part of the Recipient Device 120 or may be operably associated with (or connected to) the Recipient Device 120.

The Applicants have realized that the communication link(s) and/or communication network(s), through which the Transmitting Device 110 delivers video data to the Recipient Device 120, may have non-constant or non-fixed bandwidth or throughput or goodput; or may have dynamically-changing bandwidth or throughput or goodput; or may have a generally constant or a generally fixed bandwidth or throughput or goodput which is not necessarily known, to the Transmitting Device 110 and/or to the Recipient Device.

The Applicants have realized that it may be beneficial to estimate or measure, at the Recipient Device 120 (e.g., by also taking into account operations performed in the Transmitting Device 110 and/or data obtained by the Transmitting Device 110), the actual available bandwidth or throughput or goodput (hereinafter “the Available Bandwidth”) that is actually available to the Recipient Device 120, or that is attainable and/or usable in the connection between the Transmitting Device 110 and the Recipient Device 120. In some embodiments, such estimated value of the Available Bandwidth may be performed at or by or in the Recipient Device 120, and may optionally be transmitted to the Transmitting Device 110 and/or to other network elements or network nodes which may further utilize or take into account such data, and/or may optionally be logged or monitored by the Recipient Device 120 (and/or by the Transmitting Device 110) for quality-of-services (QoS) monitoring purposes or for quality-of-experience (QoE) monitoring purposes or for other purposes. In some embodiments, the estimation of the Available Bandwidth may be implemented as a common task or as a unified task that is co-performed by the Recipient Device 120 and the Transmitting Device 110, such that the ultimate estimation operation is performed at or by or in the Recipient Device 120, yet it is based on operations and/or calculations that may be performed at or in or by the Transmitting Device 110 and/or externally to the Recipient Device 120.

For example, realized the Applicants, based on the estimated or measured Available Bandwidth, the Transmitting Device 110 may perform one or more operations which may directly or indirectly increase the quality of the video as received (and/or displayed) by the Recipient Device 110, and/or which may reduce video transmission errors or video transmission problems (e.g., delay, latency, dropped frames, lost frames, lost video packets). In a demonstrative example, if the Available Bandwidth is estimated to be within a first range-of-values (e.g., less than 1.5 megabits-per-second), then Video Encoder 112 of Transmitting Device 113 may utilize a first set of video encoding/video compression parameters (e.g., bitrate and/or resolution that are suitable for reliable and smooth 720p video playback); whereas, if the Available Bandwidth is estimated to be within a second, greater, range-of-values (e.g., at least 1.5 megabits-per-second), then Video Encoder 112 of Transmitting Device 113 may utilize a second, different, set of video encoding/video compression parameters (e.g., bitrate and/or resolution that are suitable for reliable and smooth 1080p). The adaptive and dynamic configuration of the settings or parameters, that are used for video encoding by the Video Encoder 112, may be performed by an Encoding Parameters Modification Unit 118, which may select or determine which encoding parameters or settings to utilize, based on the currently-estimated or the most-recently-estimated value of Available Bandwidth.

The Applicants have realized that in order to achieve and/or ensure the highest-possible video quality and/or robustness, it may be beneficial to dynamically set, modify, and/or fine-tune the video encoding bitrate (or, the video encoding bitrate) that is utilized by the Video Encoder 112; for example, such that the resulting, encoded, video packets or video frames would be fully and reliably and timely transmitted over the communication link(s) and/or communication network(s), and/or would be fully and reliably and timely received at the Receiver 121 of the Recipient Device 120. For example, in some embodiments, the Available Bandwidth may be estimated to have a value of AB megabits-per-second (e.g., 2.3 megabits-per-second); and based on this estimated value, the Video Encoder 112 may be dynamically configured to encode video at a video encoding bitrate that is slightly less (e.g., 3 or 5 or 8 or 10 or 15 or 20 percent less) than said Available Bandwidth (e.g., using a video encoding bitrate of 2.2 megabit-per-second, which is slightly smaller than the Available Bandwidth of 2.3 megabit-per-second).

Accordingly, in some embodiments, operations for estimating the Available Bandwidth may be performed or co-performed, or may be distributed across, a first component which is denoted Available Bandwidth Estimator 135R and is located at the Recipient Device 120, and a second component which is denoted Available Bandwidth Estimator 135T and is located at the Transmitting Device 110. For example, the Recipient Device 120 may comprise an Available Bandwidth Estimator 135R, which may estimate or measure the Available Bandwidth for the particular communication link or connection that connects the Transmitting Device 110 and this particular Recipient Device 120; and which may operate in cooperation with a corresponding Available Bandwidth Estimator 135T in the Transmitting Device 110. Based on the estimated or measured Available Bandwidth (e.g., which may be ultimately estimated at the Recipient Device 120, and which may be periodically or continuously reported or conveyed or transmitted back from the Recipient Device 120 to the Transmitting Device 110, via a control message), an Encoding Bitrate Modification Unit 115 may dynamically configure or re-configure the Video Encoder 112 that is associated with (or included in) the Transmitting Device 110, and/or may dynamically modify the video encoding bitrate and/or other video encoding parameters that are utilized by such Video Encoder 112, in order to match the estimated Available Bandwidth and/or in order to cause the Video Encoder 112 to generate video packets or video frames that (on the one hand) can be fully and reliably and timely delivered to the Recipient Device 120, and (on the other hand) carry the highest-possible quality of video that can be delivered via that particular Available Bandwidth.

In accordance with some embodiments, the communication link between the Transmitting Device 110 and the Recipient Device 120 comprises two or more communication links; for example, a first communication link 151 having a first bandwidth value (R1); then, a second communication link 152, such as a communication network 150, having a second bandwidth value (R).

In some embodiments, the first communication link 151 may be a wired communication link; for example, an Ethernet cable which may carry data at a bandwidth (R1) of 100 megabit-per-second or even 1 gigabit-per-second. In contrast, the second communication link 152 may typically have a bandwidth (R) that is smaller than R1, such that R<R1. However, the second communication link 152 may often be comprised of a communication network having various network elements or network nodes (e.g., router, switch, hub, cellular base station, wireless access point, cell tower, cellular site), which may have buffering capabilities and burst-reception/burst-transmission capabilities; such that, for example, the second communication link 152 or its associated communication network may be able to receive short bursts of data at a bandwidth rate that is greater than R, and may temporarily store internally the burst-of-data, and may store the burst internally, and may transmit it to the Recipient Device 120 at the rate R.

In some embodiments, system 100 may utilize a mechanism for estimating the Available Bandwidth of the actual communication link (or, chain-of-links) that delivers video data from the Transmitter Device 110 to the Receiver Device 120. The mechanism may be implemented via an Available Bandwidth Estimator 135T, which may be part of the Transmitting Device 110 or may be associated therewith; and/or via an Available Bandwidth Estimator 135R, which may be part of the Recipient Device 120 or may be associated therewith; or, via cooperation between these two Estimators (135T, 135R). The mechanism for estimating the Available Bandwidth may utilize one or more of the estimation methods, and/or other operations, that are described herein.

In some embodiments, system 100 may optionally utilize a mechanism for estimating the Available Bandwidth “from above”; for example, by periodically checking whether all the bits of that transmission were received at the Recipient Device 120, as well as checking their actual time of receipt. Recipient Device may comprise a unit which may be referred to as “Receiver-Side Available Bandwidth Estimator From Above” 115. According to their mechanism of operation, from time to time (e.g., every K seconds; wherein K may be, for example, 5 or 10 or 20 seconds, or other pre-defined value), the Transmitter 113 transmits a burst or batch or group of N bits, at a rate of R2 megabit-per-second; such that R1>R2>R. The Receiver 121 is aware of the expected time and size of each transmission-burst or transmission-batch or transmission-group; for example, as such data (namely, the expected time and size of each transmission-burst or transmission-batch or transmission-group) may be pre-defined at the Receiver 121, and/or based on a control message or a control signal by which the Transmitter 113 conveys to the Receiver 121 the expected time and size of each such transmission-burst. The Receiver 121 tracks and identifies the exact time-point, denoted t₁, at which the Receiver 121 received the first bit of the transmission-batch or transmission-group or transmission-burst. The Receiver 121 also tracks and identifies the exact time-point, denoted IN, at which the Receiver 121 received the last (the Nth) bit of that batch or group or burst of bits. The Recipient Device 120 then calculates the Available Bandwidth as estimated “from above”, by using (for example) one of the following equations:

$${R}_{estimated - from - above} = {B}_{( N - 1 )} / ( {t}_{N} - {t}_{1} )$$

$${R}_{estimated - from - above} = {B}_{N} / ( {t}_{N} - {t}_{1} )$$

In some embodiments, the Available Bandwidth as estimated “from above”, may be conveyed or reported or otherwise indicated by the Recipient device 120 to the Transmitter Device 110; for example, via a control message or control signal or a feedback channel; and that value of Available Bandwidth may then be utilized by or at the Transmitting Device 110 to adjust or modify or configure the video encoding settings or the video encoding parameters of the Video Encoder 112, and particular the video encoding bitrate that is used by the Video Encoder 112.

In accordance with some embodiments, an additional or different or improved method may be used for estimating the Available Bandwidth; and such method may be referred to as estimating the Available Bandwidth “From Below”. It may be implemented, for example, using Recipient-Side Available BW Estimator “From Below” 114.

For example, at the Transmitting Device 110, a Bitrate Selector 116 may select a candidate rate of R3 (megabits-per-second); by applying one or more rate selection rules that generate a candidate rate R3 that is assumed (by the Transmitting Device 110) to be smaller than R. It is not guaranteed that R3<R, since the value of R may vary over time due to various bandwidth-influencing factors (e.g., weather conditions, current location of the Recipient Device 120 which may be moving, current nearby topology, network load, network congestion). For every video frame that is intended to be transmitted from the Transmitting Device 110 to the Recipient Device 120, the Transmitter 113 of the Transmitting Device 110 (and/or optionally, in some implementations, a Payload Generator 117 or other assisting component) generates a payload having a size of B bits; wherein B=R3/FPS, wherein FPS indicates the frames-per-second attribute of that video (e.g., FPS may be 24 or 30 or 60, or other suitable value). The Transmitter 113 (and/or optionally, in some implementations, the Payload Generator 117 or other assisting component) further performs packetization of that payload of B bits, into a number of packets that is denoted Mₜₒₜₐₗ, whose value may vary among frames of the same video.

The generated Payload includes a header, which may indicate or carry therein the values of B or Mₜₒₜₐₗ or both. In some embodiments, optionally, the value of B or the value of Mₜₒₜₐₗ, or both of them, may be sent only once from the Transmitting Device 110 to the Recipient Device 120; or may be sent once we transmission session, or once per T minutes (e.g., once per 5 or 10 minutes), or the like. In some embodiments, optionally, the Recipient Device 120 may be configured to operate based on a pre-defined rule that each packet has a fixed, non-changing, size in bytes that is known to the Recipient Device 120 (e.g., conveyed once by the Transmitting Device 110 to the Recipient Device 120). It is noted that in some embodiments, it may be helpful for the Recipient Device 120 to know the size in bits of each video frame; for example, particularly if the video frame size (in bits) is non-fixed across frames, and/or if the Packet Error Rate (PER) (e.g., the number of incorrectly received packets (or defective packets) divided by the total number of received packets) is high or is greater than a pre-defined threshold value (since, for example, a low PER may allow the Recipient Device 120 to count the number of bits received; whereas such bit counting would not be reliable in case of a high PER).

The header is heavily protected against packet drops, by applying to the header a Forward Error Correction (FEC) scheme, to ensure that the header is received at the Recipient Device 120 even if some (or even most) of the Mₜₒₜₐₗ packets are not received at the Recipient Device 120. Then, the Transmitter 113 of the Transmitting Device 110 transmits those Mₜₒₜₐₗ packets, at a high transmission rate denoted R1 (for example, R1 being 1 gigabit-per-second, or 800 megabit-per-second). Since R1>R3, the time-duration of the transmission of that Payload, at the output point of the Transmitter 113, is smaller than (1/FPS).

At the Recipient Device 120, for each video frame, the Receiver 121 (or another assisting component) extracts the value of Mₜₒₜₐₗ from the header. At the Recipient Device 120 side, for each video frame (of the Payload, which may also be referred to as the Video Payload) that the Receiver 121 receives, the Receiver 121 extracts the value of Mₜₒₜₐₗ from the header; and tracks and stores the arrival time-points (denoted t₁, t₂, . . . t_{M}) of the packets that were received. It is noted that Mₜₒₜₐₗ packets of the Payload were transmitted by Transmitter 113; yet M packets were actually received at Receiver 121, such that M is smaller than or equal to Mₜₒₜₐₗ, since it is possible that one or more of the Mₜₒₜₐₗ packets were dropped or were lost; such that M denotes the last packet that was actually received at Receiver 121 for that frame.

At the Recipient Device 120, a Bandwidth Estimation Method Selector 131R checks whether the following condition (denoted “Condition A”) holds true:

$$( {t}_{M} - {t}_{1} ) \times {M}_{total} / ( M - 1 ) > ( 1 / FPS )$$

If said condition holds true, then: Bandwidth Estimation Method Selector 131R orders or commands or configures the Transmitting Device 110 and/or the Recipient Device 120 to estimate the Available Bandwidth using the above-described method of estimating the Available Bandwidth “from above”; and the Receiver-Side Available Bandwidth Estimator From Above 115 performs such Available Bandwidth estimation “from above”.

In contrast, if said condition does not hold true, then: Bandwidth Estimation Method Selector 131R orders or commands or configures the Transmitting Device 110 and/or the Recipient Device 120 to estimate the Available Bandwidth using a different method, of estimating the Available Bandwidth “from below”; and a Receiver-Side Available Bandwidth Estimator From Below 118R performs such Available Bandwidth estimation “from below”, as described herein.

In some embodiments, system 100 may substantially continuously perform the estimation of the Available Bandwidth “from above” (e.g., periodically, every 5 seconds, every 12 seconds, every N seconds, or the like); and may also perform, generally continuously or periodically or at pre-defined time intervals or time-points, the estimation of the Available Bandwidth “from below”); and a Bandwidth Estimation Method Selector 116 may operate to determine, dynamically, which one of the two estimated values should be used as the “final” or the “current” or the “more reliable” Available Bandwidth estimated value (e.g., keeping one of the two estimated values, and discarding the other of the two estimated values; and not, for example, averaging the two estimated values, since one of them is assumed to be incorrect or exaggerated).

The method of estimating the Available Bandwidth “from below” may operate as follows.

Step (A): Let X=[X₁, X₂, . . . , X_{M}], wherein Xᵢ indicates the cumulative sum of the sizes of packets 1, 2, . . . , i. In some embodiments, all the packets have the same fixed size, which may be denoted as PacketSize; and in such cases X=[1, 2, . . . , M]*PacketSize.

Step (B): Let Y=[t₁, t₂, . . . , t_{M}], wherein tᵢ indicates the arrival time of each packet.

Step (C): Let P=[P₁, P₂] be the linear fit of a first order polynomic fit of Y to X; where P₁ is the slope of the line. In some embodiments, for example, this may be determined using the following MATLAB function: P=polyfit (X, Y, 1).

Step (D): estimate the Available Bandwidth “from below”, by calculating as follows:

$${R}_{estimated - from - below} = 1 / {P}_{1}$$

In some embodiments, the Available Bandwidth as estimated “from below”, may be conveyed or reported or otherwise indicated by the Recipient device 120 to the Transmitter Device 110; for example, via a control message or control signal or a feedback channel; and that value of Available Bandwidth may then be utilized by or at the Transmitting Device 110 to adjust or modify or configure the video encoding settings or the video encoding parameters of the Video Encoder 112, and particular the video encoding bitrate that is used by the Video Encoder 112.

In some embodiments, the method for estimating the Available Bandwidth “from below”, may be improved or enhanced or modified such that it would operate on a set of multiple video frames (and their respective packets), and not only on a single frame (and its respective packets); thereby implementing a Cross-Frames estimation of Available Bandwidth “from below”, or a Multiple-Frames Based estimation of Available Bandwidth “from below”). For example, such method may operate as follows.

$$Let X = [ {x}_{11} , {x}_{12} , … {x}_{1 M 1} , … {x}_{k 1} , {x}_{k 2} , … {x}_{kMk} ] , \qquad Step ( A1 )$$

wherein Xⱼᵢ is the cumulative sum of the sizes of packets 1 through i in in frame j.

$$Let T = [ {t}_{11} , {t}_{12} , … {t}_{1 M 1} , … … ( {t}_{k 1} - ( k - 1 ) / FPS ) , ( {t}_{k 2} - ( k - 1 ) / FPS ) , … … {t}_{kMk} - ( k - 1 ) / FPS ] \qquad Step ( B1 )$$

wherein tⱼᵢ is the arrival time of packet i in frame j; and in accordance with some embodiments, the value of ((j−1)/FPS) is subtracted from all the time measurements.

Step (C1): Let P=[P₁, P₂] be the linear fit of a first order polynomic fit of T to X; wherein P₁ is the slope of the line. In some embodiments, for example, this may be determined using the following MATLAB function: P=polyfit (X, T, 1).

Step (D1): estimate the cross-frames based (or, multiple-frames based) Available Bandwidth “from below”, by calculating:

$${R}_{estimated - from - below} = 1 / {P}_{1}$$

The Applicants have realized that based on Condition A, either the value of the Available Bandwidth as estimated “from above”, or the value of the Available Bandwidth as estimated “from below”, should be selected as the “final” or “usable” or “more accurate” value that should be utilized for configuring or modifying the video encoding bitrate and/or other video encoding properties. For example, the two methods of estimation may be executed in parallel, or in series (e.g., immediately one after another), or in two time-periods that at least partially overlap; and may generate two estimated candidate values of Available Bandwidth. Then, if Condition A holds true, then only the value of Available Bandwidth that was estimated “from above” would be utilized, and the other value (the Available Bandwidth as estimated “from below”) would be discarded. In contrast, if Condition A does not hold true, then only the value of Available Bandwidth that was estimated “from below” would be utilized, and the other value (the Available Bandwidth as estimated “from above”) would be discarded. In some embodiments, Condition A may be utilized in conjunction with one or more other pre-defined rules or conditions, or may be replaced by one or more other rules or conditions or method selection logic.

It is noted that in some embodiments, the transmission time-duration of the entirety of the payload of Mₜₒₜₐₗ packets of encoded video is configured to be smaller than 1/FPS, by a particular margin; and said particular margin is selected such that the Bandwidth Estimation Method Selector selects the from-below estimate of Available Bandwidth, discards the from-above estimate of Available Bandwidth, at least 75 percent of times in which both of said estimated values are available for selection by the Bandwidth Estimation Method Selector. This may occur since the transmitting device and/or its video encoder use a margin (which may be dynamically modified) to ensure that the transmitted bandwidth is below the actual available bandwidth in approximately 75 percent of the times.

In some embodiments, optionally, a Baseline Value of estimated Available Bandwidth is estimated or established for a particular recipient device, using one or more suitable processes or techniques; and then, the Baseline Value may be used in order to perform the method of estimating the Available Bandwidth “from above” (namely, by transmitting to the recipient device a payload at a transmission rate that is greater than said Baseline Value); and also, the Baseline Value may be used in order to perform the method of estimating the Available Bandwidth “from below” (namely, by transmitting to the recipient device a payload at a transmission rate that is smaller than said Baseline Value); and one or more selection rules, such as “Condition A” described above, may be applied in order to establish the actual Available Bandwidth that would be used by the transmitting device until the next update cycle of that value. The most recently estimated Available Bandwidth is then utilized, in the next iteration, as the Baseline Value for the next estimation of the Available Bandwidth “from above” and for the next estimation of the Available Bandwidth “from below”; and so forth. The initial Baseline Value of the estimated Available Bandwidth may be established or determined by an Initial Baseline Value Estimator unit (for example, denoted 119T if implemented at the Transmitting Device, and/or denoted 119Rif implemented at the Recipient Device).

In some embodiments, the initial Baseline Value may be selected randomly or pseudo-randomly from a range of suitable values; or, may be selected based on one or more metadata attributes of the recipient device (e.g., the end-user device, or the device that is intended to consume the video data). In a first example, the Internet Protocol (IP) address of the recipient device may be mapped to a block of IP addresses that are known to belong to (or be owned by, or be associated with) a particular large organization, and therefore the Baseline Value may be set to (for example) 90 megabit-per-second. In a second example, other indicators of attributes of the recipient device may indicate that it is a cellular device (e.g., smartphone) that is connected to the transmitting device via a 4G LTE cellular communication network, and therefore the Baseline Value may be set to (for example) 30 megabit-per-second. In a third example, geo-location of the IP address of the recipient device may indicate that it is located in a particular geographical location or region that is known to lack broadband service greater than 100 megabit-per-second, and therefore the Baseline Value may be set to (for example) 10 megabit-per-second. In a fourth example, data about the Internet Service Provider (ISP) of the recipient device may indicate that this ISP provides a guaranteed bandwidth of at least 50 megabit-per-second to its lowest-tier customers, and therefore the Baseline Value may be set to (for example) 48 megabit-per-second. Other suitable rules or indicators or metadata, or attributes or characteristics of the recipient device and/or the communication link and/or the communication network and/or the service provider and/or their geo-location, may be used to establish the Baseline Value.

In some embodiments, the Payload that is sent from the Transmitting Device 110 to the Recipient Device 120, consists entirely an exclusively of actual Video Data that is intended to be parsed and then displayed at the Recipient Device 120 (on its display unit, or on a display unit that is associated with that Recipient Device 120); and optionally including FEC data that protects at least the header of the Payload. In some embodiments, the Payload does not include any (or, it excludes) non-video data, or data that is not intended to be parsed and displayed on a display unit (including its associated FEC codes); or in some embodiments, the Payload does not include any non-video data other than having the Header which represents one or two particular parameters as described above or herein. This is in direct contrast with conventional methods of estimating bandwidth, which typically send a dedicated non-video data or “training bits” or “testing bits” as a “trial data” whose only purpose and intention and utilization is for the purpose of estimating the bandwidth of the channel. One of the goals of system 100 is to enable high-quality video transmission from the Transmitting Device 110 to the Recipient Device 120; and thus the Payload that is utilized by system 100 for estimating the Available Bandwidth consists of actual video data, with no overhead or with minimal overhead (namely, with no additional data that does not directly describe video content, and does not directly protect video content via FEC codes).

As mentioned above, some systems may estimate bandwidth by sending bursts of N bits at transmission rate R2, wherein such that R1>R2>R, and while the Recipient Device is explicitly aware in advance of the expected time and size of each transmission burst. However, since the Transmitting Device is sending the burst intentionally above the most-recently-estimated Available Bandwidth, the Transmitting Device must assume that at least some of the transmitted data would get lost or would not be received; and therefore, the Transmitting Device is prevented from sending actual video data in order to measure the Available Bandwidth, and the Transmitting Device is constrained to send (for this purpose) only non-video “training bits”, to avoid the risk of actual video data being lost in transmission. In contrast, system 100 does not send any overhead data beyond the actual video data itself (and also associated FEC codes). Accordingly, some embodiments innovatively transmit and receive only video data, which is also utilized for estimating Available Bandwidth, without sending any other non-video data, and while only transmitting and receiving data needed for the purpose of reliable transmission of video.

In some embodiments, it may be possible that occasionally, a small portion of the transmitted video data, that is transmitted for the purposes of estimating the Available Bandwidth, might be transmitted (unintentionally) at a transmission rate which is in fact slightly greater that the actual Available Bandwidth. However, system 100 may be configured to address this risk and to prevent it from occurring, since system 100 selectively utilizes the estimated value of the Available Bandwidth that was estimated “from above” only in situations where the Transmitting Device 110 (which is a non-overhead transmitting device, that transmits only video data and no overhead) indeed happened to transmit video data “from above” (namely, at a transmission rate that is slightly greater than the most-recently-estimated value of Available Bandwidth). It is also noted that in system 100, the Transmitting Device is configured to never intentionally transmit video data at a transmission rate that is greater than the most-recently-estimated value of Available Bandwidth; and the Transmitting Device is always configured to transmit video data at a transmission rate that is lower by at least P percent (e.g., P being 2 or 4 or 5 percent) smaller than the most-recently-estimated value of Available Bandwidth; however, it is possible that the actual bandwidth of the communication channel would suddenly or abruptly drop or decrease, and the Bandwidth Estimator From Above would quickly detect such situation, in accordance with some embodiments.

In some embodiments, innovatively, both of the estimation methods (namely, the method of estimating the Available Bandwidth “from above”, and the method of estimating the Available Bandwidth “from below”) are active and operational all the time, or continuously or substantially continuously, or at pre-defined time intervals that are generally small (e.g., every 5 seconds, every 8 seconds, or the like); as the two methods do not require to transmit any overhead (or, any substantial overhead) or any non-video data; and both of the estimator units (namely, the Available Bandwidth estimator “from above”, and the Available Bandwidth estimator “from below”) are continuously working and estimating values; yet, most of the time, the values of Available Bandwidth that are estimated “from above” are discarded based on “Condition A” described above (or based on other suitable pre-defined rules or conditions); and still, the estimated value of the Available Bandwidth “from above” is readily available for selection and utilization, in the relatively rare times that “Condition A” dictates that the estimate “from above” should be used (as the actual value of Available Bandwidth) and that the estimate “from below” should be discarded.

In some situations, jitter may exist in system 100, such that there are variations in the time delay between transmission of a signal and reception of that signal. In some embodiments, system 100 may be configured to perform jitter averaging, or may be configured to correctly estimate the Available Bandwidth even with a jittery communication channel, by utilizing (for the purpose of estimating the Available Bandwidth) a plurality of video packets which are spread over time in a non-uniform way, since each transmitted video packet is at a different time-offset relative to a beginning of its respective video frame. For example, a Jitter Averaging Unit 132 may be part of (or, may be operably associated with) the Payload Generator 117 and/or the unit(s) that perform the estimate of the Available Bandwidth “from below” or may be a component of the recipient device; and may create a multiple-frames payload or a cross-frames payload, of M video packets, that would be utilized as the Payload.

For example, referring in this context to the above-described method Cross-Frames estimation of Available Bandwidth “from below”, or a Multiple-Frames Based estimation of Available Bandwidth “from below”), the following may be used:

$$Let X = [ {x}_{11} , {x}_{12} , \text{} … {x}_{1 M 1} , \text{} … {x}_{k 1} , {x}_{k 2} , … {x}_{kMk} ] , \qquad Step ( A2 )$$

wherein Xⱼᵢ is the cumulative sum of the sizes of packets 1 through i in in frame j.

$$Let T = [ {t}_{11} - {b}_{1} , {t}_{12} - {b}_{1} , … , {t}_{1 M 1} - {b}_{1} , … , {t}_{k 1} - {b}_{k} , {t}_{k 2} - {b}_{k} , … , {t}_{kMk} - {b}_{k} ] \qquad Step ( B2 )$$

wherein tⱼᵢ is the arrival time of packet i in frame j;
wherein bⱼ is the intercept of the line that fits the samples of T and X in frame j with the Taxis. In a demonstrative implementation that uses MATLAB terms,

$$[ {a}_{k} , {b}_{k} ] = polyfit ( X ( j ) , T ( j ) , 1 )$$

wherein the Y-axis intercept (bₖ) is utilized (e.g., it is being subtracted in the T calculations, shown above), and the slope of the line (aₖ) is not used.

In accordance with some embodiments, the utilization of Step (B2) instead of the previously-discussed Step (B1), may cause the bandwidth estimation methods to be more robust to jitter in frame timing. This improvement may be important in various types of video transmission; for example, if the communication channel or the communication network(s) between the Transmitting Device 110 and the Recipient Device 120 cause or introduce jittery communications, or jittery time-points of packet arrival times at the Recipient Device 120, or other jitter impairment; or if the source video is obtained from a camera that generates video frames with non-constant time difference between frames; or, if a video encoder or video compression unit adds (or causes) jitter, since the time to compress each video frame is not constant (e.g., depending on the visual content depicted in each frame; a visually-complex frame may take longer to encode).

Step (C2): Let P=[P₁, P₂] be the linear fit of a first order polynomic fit of T to X; wherein P₁ is the slope of the line. In some embodiments, for example, this may be determined using the following MATLAB function: P=polyfit (X, T, 1).

Step (D2): estimate the cross-frames based (or, multiple-frames based) Available Bandwidth “from below”, by calculating:

$${R}_{estimated - from - below} = 1 / {P}_{1}$$

In some embodiments in which Jitter Averaging is performed or is intended to be achieved, realized the Applicants, there may be a tradeoff between: (i) long-term jitter averaging, which may produce more-accurate results but may be slow to respond to (or to track) changes in the communication channel, and (ii) short-term jitter averaging, which may produce less-accurate results but may be fast to respond to (or to track) changes in the communication channel. Therefore, some embodiments may utilize an Adaptive Jitter Averaging Unit 133, which enables the unit(s) that perform the estimate “from below” of Available Bandwidth to track the standard deviation σ₁ of the error of the slope estimation in the linear fit; for example, calculated as follows; wherein A indicates the averaging size (e.g., in bits, or in the number of packets):

$${σ}_{1} = \sqrt{\frac{1}{A - 2} . \frac{{\sum }_{i = 1}^{A} {( {y}_{i} - {P}_{1} \cdot {x}_{i} - {P}_{2} )}^{2}}{{\sum }_{i = 1}^{A} {( {x}_{i} - \overline{x} )}^{2}}}$$

Then, based on the standard deviation of the error σ₁, a pre-defined control logic in the Adaptive Jitter Averaging Unit 133 operates to adaptively set or modify the averaging size (A), in order to keep the error (or, the calculated standard deviation of the error) beneath a pre-defined target or threshold value, or within a pre-defined range-of-values.

In some embodiments, adaptive of differential video encoding may be performed by the Video Encoder 112, by modifying or setting or re-configuring video encoding parameters to obtain the best-possible quality of video for a particular value of current Available Bandwidth as estimated by system 100. In some embodiments, one or more equations or formulas may be used for this purpose; for example, a formula that indicates that if the Available Bandwidth is currently N bits-per-second, then Video Encoder 112 should encode video at a bitrate of K×N bits-per-second, wherein K is a fraction that is smaller than one (or, in some embodiments, is smaller than or equal to one), or is a fraction that is slightly smaller than one (e.g., K being 0.98 or 0.95). In other embodiments, one or more lookup tables may be used, to indicate additional and/or other video encoding parameters which may be used to adapt Video Encoder 112 to a particular value of estimated Available Bandwidth; for example, a lookup table that indicates that if the estimated value of Available Bandwidth is in a first range of bits-per-second, then Video Encoder 112 should encode the source video to generate a 720p encoded output; whereas, if the estimated value of Available Bandwidth is in a second, different, range of bits-per-second, then Video Encoder 112 should encode the source video to generate a 1080p encoded output; or similar rules, indicating that if the estimated value of Available Bandwidth is within a particular range-of-values, then Video Encoder 112 should encode the video at a particular bitrate and/or output resolution, and/or by using a particular encoding scheme or other configurable or modifiable encoding parameters. Encoding Parameters Modification Unit 118 may be responsible for dynamically re-configuring the Video Encoder 112, and/or for dynamically setting or modifying the video encoding parameters or settings, based on the currently-known value or the most-recently-estimated value of the Available Bandwidth.

Some embodiments may enable real-time encoding or near-real-time encoding of live video, in an adaptive manner that takes into account the estimated Available Bandwidth of a particular recipient and/or of a particular communication link (or, a particular chain of communication links that connects the transmitting device to this particular recipient device). Some embodiments, thus, do not require to produce and to store in advance multiple versions of the same video (e.g., a 480p version, a 720p version, a 1080p version), thereby saving processing resources, time resources, and/or storage resources; and accordingly, some embodiments do not merely select among a set of finite plurality of pre-produced video versions of the same content, but rather, some embodiments dynamically encode a singular video (and particularly, a singular live-video stream) according to dynamically-determined video encoding parameters that would yield the best-possible quality of video at this particular recipient device via this particular communication link (or, this particular chain or set of communication links).

Some embodiments may perform Variable BitRate (VBR) encoding; such that, for example, the content of a first time-segment of a video (e.g., the first three seconds) is encoded using a first video encoding bitrate; whereas the content of a subsequent time-segment of the same video (e.g., the next five seconds) is encoded using a second, different, video encoding bitrate; and so forth; and the VBR may be adapted to the most-recently-estimated Available Bandwidth value that matches the time-point at which the encoding is performed. For example, the encoding of the video content of the 35th second of the video, is dynamically performed based on the Available Bandwidth that was estimated (for example) at 34.7 seconds into the video; and subsequently, the encoding of the video content of the 48th second of the video, is dynamically performed based on the Available Bandwidth that was estimated (for example) at 47.2 seconds into the video.

Some embodiments may enable transmission and reception of video, particularly video that is compressed or encoded with advanced compression standards such as High Efficiency Video Coding (HEVC) or H.265 or MPEG-H Part 2 video compression standard, or H.264 or MPEG-4 Part 10 or Advanced Video Coding (AVC or MPEG-4 AVC) video compression standard; and/or with regard to compressed video that is represented using Coarse data portions and Fine (or Refinement) data portions. Some embodiments may be utilized in conjunction with video that is compressed or encoded in accordance with a Scalable Video Coding (SVC) technique, such as, using H.264 SVC or using the Annex G extension of the H.264/MPEG-4 AVC video compression standard; or by a similar technique in which a high-quality video stream is encoded into two or more subset bitstreams, wherein a subset bitstream may represent a version having lower spatial resolution (smaller screen) and/or a version having lower temporal resolution (lower frame-rate) and/or a version having lower quality or fidelity or Signal-to-Noise Ratio (SNR). In some embodiments, for example, the video may comprise Coarse portions and Refinement portions as described in United States patent application publication number US 2016/0073122 A1, titled “Wireless transmission of high-quality video”, which is hereby incorporated by reference in its entirety.

For demonstrative purposes, some portions of the discussion herein may relate to utilization of Forward Error Correction (FEC), as a non-limiting example; other suitable methods may be used for error correction or for protection of data integrity, or for providing data redundancy, such as Reed-Solomon error correction and/or other techniques.

In some embodiments, the system may operate as described herein, referring separately to the Transmitting Device and to the Recipient Device.

At the Transmitting Device, the transmitter selects a transmission rate, denoted R3. For example, the initial value of R3 may be 95 percent of a most-recently-known value of available bandwidth; or may be a particular pre-defined value. At every video frame, the transmitter generates a payload of L bits, wherein L=R3/FPS; namely, the selected transmission rate (R3), divided by the frames-per-second (FPS) of the video intended for transmission. Those L bits are packetized at the Transmitting Device into Mₜₒₜₐₗ packets; the value of Mₜₒₜₐₗ, which is the total number of packets that those L bits occupy, varies across frames. The transmitter attaches to the payload of L bits a Header, which includes therein the value of L and/or the value of Mₜₒₜₐₗ. The header is heavily protected (with FEC or other error correction mechanism) against packet drops, packet loss, and/or against other errors. The Transmitting Device transmits those L bits with their Header, by transmitting those Mₜₒₜₐₗ packets.

It is noted that the Transmitting Device and its Transmitter perform said transmissions without knowing whether the Recipient Device has zero or one or two or other number of Bandwidth Estimator unit(s), and/or without relying on the type of such possible Bandwidth Estimator unit(s) that may be operational in the Recipient Device (e.g., a “From Above” bandwidth estimator, a “From Below” bandwidth estimator). The Transmitting Device and its Transmitter maintain the above-mentioned transmission scheme, regardless of the particular existence and/or type and/or configuration of Bandwidth Estimator unit(s) in the Recipient Device.

At the Recipient Device, as step 1 of 4, the arrival time (or time-points) of each received packet is monitored and stored. For each video frame, the Recipient Device extracts the value of Mₜₒₜₐₗ from the header; and stores the arrival time of each packet that was received; for example, wherein t₁ indicates the time of arrival of packet number 1; wherein t₂ indicates the time of arrival of packet number 2; and so forth until IM which indicates the time of arrival of the last packet (M) that was actually received at the Recipient Device and that belongs to that video frame. If no packets were dropped or lost during transport from the Transmitting Device to the Recipient Device, then M is equal to Mₜₒₜₐₗ. If one or more packets were dropped or lost during transport from the Transmitting Device to the Recipient Device, then M may be smaller than Mₜₒₜₐₗ, as M denotes the number of the last packet of that video frame that was actually received at the Recipient Device. It is also noted that subsequent time-points, such as t_{Mtotal+1} or t_{Mtotal+2}, are time-points of arrival of video packets that belong to the next (the following, the consecutive) video frame. In some situations, it is possible that one or more packets would get lost in transport, and still the value of M may be equal to Mₜₒₜₐₗ; for example, Mₜₒₜₐₗ may be equal to 4, and the recipient device receives packet numbers 1 and 2 and 4, and thus M=4=Mₜₒₜₐₗ; whereas in another scenario, if the recipient device receives packets 1 and 2 and 3 (and not 4), then M=3 and thus M<Mₜₒₜₐₗ.

The Recipient Device also selects a number (N) and stores the arrival time of the Nth packet. If the number N is smaller than or equal to Mₜₒₜₐₗ, then the Nth packet is part of the same frame of packet number 1. If the number N is greater than Mₜₒₜₐₗ, then the Nth packet belongs to a later (a subsequent) video frame, and not to the video frame to which packet number 1 belongs. It is noted that both of these situations are considered valid. In some embodiments, the value of N selected by the Recipient Device may be, for example, 50 or 64 or 80 or 100; or may be 2 or 4 or 8 or 10 or 12 times the average value of Mₜₒₜₐₗ; or may be smaller than 15 times the average value of Mₜₒₜₐₗ.

At the Recipient Device, as step 2 of 4, the Bandwidth Estimator From Above operates to perform the following operations. In accordance with some embodiments, B_{(N-1)} is the total number of bits that were sent in the set of packets from packets number 1 through packet number (N−1). In some embodiments, when B_{(N-1)} is evaluated, if the packet size is fixed then B_{(N-1)} equals to the packet size times (N−1); whereas, if the packet size is not fixed, then a value of N can be selected as a value that contains full frames, and in such case, B_{(N-1)} equals to the sum of the L values of these frames.

The Recipient Device then calculates the Available Bandwidth as estimated “from above”, by using (for example) one of the following equations:

$${R}_{estimated - from - above} = {B}_{( N - 1 )} / ( {t}_{N} - {t}_{1} )$$

$${R}_{estimated - from - above} = {B}_{N} / ( {t}_{N} - {t}_{1} )$$

At the Recipient Device, as step 3 of 4, the Bandwidth Estimator From Below operates to perform the following operations for estimating the Available Bandwidth “from below”.

Step (A): Let X=[X₁, X₂, . . . , X_{M}], wherein Xᵢ indicates the cumulative sum of the sizes of packets 1, 2, . . . , i. In some embodiments, all the packets have the same fixed size, which may be denoted as PacketSize; and in such cases,

$${X}_{i} = PacketSize * {\sum }_{j = 1}^{í} j$$

Step (B): Let Y=[t₁, t₂, . . . , t_{M}], wherein tᵢ indicates the arrival time of each packet.

Step (C): Let P=[P₁, P₂] be the linear fit of a first order polynomic fit of Y to X; where P₁ is the slope of the line. In some embodiments, for example, this may be determined using the following MATLAB function: P=polyfit (X, Y, 1).

Step (D): estimate the Available Bandwidth “from below”, by calculating:

$${R}_{estimated - from - below} = 1 / {P}_{1}$$

Then, as step 4 of 4 at the Recipient Device, the Recipient Device determines whether to select (to use) either (I) the available bandwidth as estimated from above, or (II) the available bandwidth as estimated from below; based on one or more pre-defined selection rules or conditions.

For example, at the Recipient Device, the Bandwidth Estimation Method Selector 131R checks whether the following condition (denoted “Condition A”) holds true:

$$( {t}_{M} - {t}_{1} ) \times {M}_{total} / ( M - 1 ) > ( 1 / FPS )$$

If Condition A holds true, then the Bandwidth Estimation Method Selector 131R of the Recipient Device determines that the Available Bandwidth value to be utilized is the value of the available bandwidth as estimated “From Above”.

If Condition A does not hold true, then the Bandwidth Estimation Method Selector 131R of the Recipient Device determines that the Available Bandwidth value to be utilized is the value of the available bandwidth as estimated “From Below”.

In some embodiments, the operations of the Bandwidth Estimation Method Selector 131R are indeed performed in the Recipient Device; which then sends to the Transmitting Device only the value of the estimated bandwidth that was selected (in the Recipient Device) out of the two calculated values (“from above” or “from below”). In other embodiments, optionally, the Recipient Device may send both of those estimated values to the Transmitting Device, and may also send to the Transmitting Device other information (e.g., the values of the parameters of Condition A mentioned above); and the Transmitting Device may perform on its side the selection of the estimated bandwidth value that should be used, via its own optional unit of Bandwidth Estimation Method Selector 131T, which may similarly operate based on Condition A and/or based on other conditions or selection criteria.

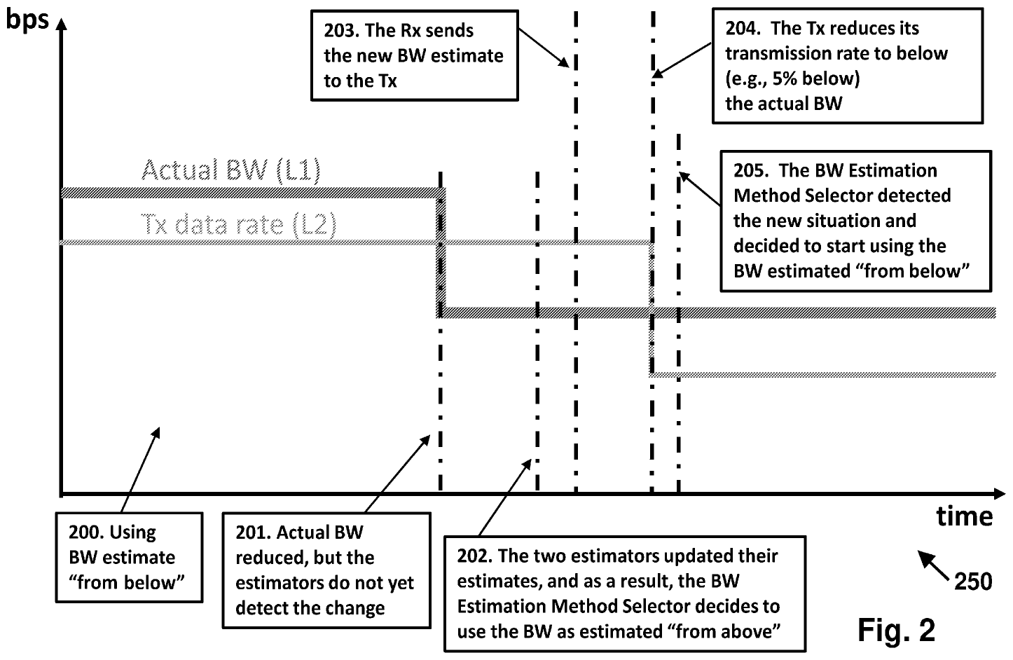

Reference is made to FIG. 2, which is an illustration of a chart 250 demonstrating a non-limiting example of changes in actual available bandwidth of the communication channel (Line L1) and changes in the transmission data-rate (the transmission rate) that is utilized by the Transmitting Device (Line L2), in accordance with some embodiments. The horizontal axis indicate time; the vertical axis indicate rate in bits-per-second (or other suitable rate units). Several boxes, 200 through 205, indicate several demonstrative time-points.

As indicated in box 200, initially the transmission rate that is utilized by the Transmitting Device is smaller (e.g., by 5 or 10 percent) than the actual available bandwidth. Hence, the bandwidth estimate “from below” is utilized.

As indicated in box 201, the actual bandwidth of the communication channel was abruptly reduced or decreased; however, the bandwidth estimation units (of the Recipient Device) did not yet detect the decrease in the actual available bandwidth; and did not yet report such decrease to the Transmitting Device; and therefore, the Transmitting Device continues to transmit data at the previous transmission rate without yet changing its transmission rate.

As indicated in box 202, the two bandwidth estimation units of the Recipient Device have operated, and have updated their estimated values of available bandwidth; and as a result, the Bandwidth Estimation Method Selector (of the Recipient Device) decides to use the bandwidth value as estimated “from above”.

As indicated in box 203, the Recipient Device sends to the Transmitting Device a message indicating the new value of the estimated bandwidth (that was selected in box 202).

As indicated in box 204, the Transmitting Device receives from the Recipient Device the message that indicates the updated currently-estimated value of the available bandwidth of the communication channel; and the Transmitting Device reduces its transmission rate to below the actual available bandwidth (e.g., 5 or 8 or 10 or 15 percent below it).

As indicated in box 205, the Bandwidth Estimation Method Selector (of the Recipient Device) detects the updated situation; and determines to start using the estimated bandwidth value that is estimated “from below” as the currently-estimated available bandwidth. The flow may continue, for example, with the Recipient Device sending to the Transmitting Device further messages or signals, indicating the new value(s) of the estimated bandwidth as they are estimated from time to time.

In some embodiments, a system comprises a transmitting device and a recipient device. The transmitting device is configured to transmit video data to the recipient device over a communication network having a non-fixed bandwidth. The recipient device is operably communicative with said communication network over a communication link having a non-fixed bandwidth of R bits-per-second, wherein R is varying over time. The recipient device comprises: an Available Bandwidth Estimator, to estimate a currently-available bandwidth of said communication link between said communication network and said recipient device; wherein the Available Bandwidth Estimator of the recipient device comprises: (a1) a Bandwidth Estimator From Above, configured to generate a from-above estimate of Available Bandwidth of said communication link, based on a first analysis performed by the recipient device which divides (i) the total number of bits which arrived during a certain time interval by (ii) the duration of that time interval; wherein a size in bits of each frame is conveyed from the transmitting device to the recipient device; (a2) a Bandwidth Estimator From Below, configured to generate a from-below estimate of Available Bandwidth of said communication link, based on a second, different, analysis performed by the recipient device which analyzes time-of-arrival of packets from a set of Mₜₒₜₐₗ packets of encoded video data that was transmitted from the transmitting device to the recipient device, wherein said payload of Mₜₒₜₐₗ packets of encoded video data were transmitted by the transmitting device; wherein a header of said payload of Mₜₒₜₐₗ packets of encoded video, stores at least one of: (i) the value of Mₜₒₜₐₗ, (ii) the total size in bits of said payload of Mₜₒₜₐₗ packets of encoded video; (a3) a Bandwidth Estimation Method Selector, configured to dynamically select, from time to time, based on a pre-defined set of selection rules, either (i) the from-above estimate of Available Bandwidth, or (ii) the from-below estimate of Available Bandwidth, as a currently-estimated Available Bandwidth value that should be utilized for modification of video encoding parameters at the transmitting device; wherein the recipient device comprises a transmitter 124 that is configured to periodically transmit, from the recipient device to the transmitting device, a message indicating a current value of the currently-available bandwidth as estimated by the Available Bandwidth Estimator of the recipient device. The transmitting device further comprises: (b1) a configurable video encoder, that encodes a source video into encoded video data; (b2) an Encoding Parameters Modification Unit, to dynamically configure said configurable video encoder to dynamically generate said encoded video data by using a video encoding bitrate that is lower than 95 percent (or 98 percent, or 92 percent, or 90 percent, or other pre-defined threshold value or dynamically-modified threshold value) of the current value of the currently-available bandwidth as estimated by the Available Bandwidth Estimator of the recipient device.

In some embodiments, the payload of Mₜₒₜₐₗ packets of encoded video data comprises Mₜₒₜₐₗ packets for each video frame of the encoded video data.

In some embodiments, the payload of Mₜₒₜₐₗ packets of encoded video data comprises Mₜₒₜₐₗ packets for each video frame of the encoded video data; wherein the payload of Mₜₒₜₐₗ packets of encoded video data is generated at the transmitting device to consist of exactly B bits; wherein B is calculated by the transmitting device as B=R3/FPS; wherein FPS indicates the frames-per-second rate of the source video; wherein R3 is selected by the transmitting device to have a value that is up to 90% of the most-recently-estimated value of R.

In some embodiments, the Bandwidth Estimation Method Selector applies the following set of selection rules:
check a validity of the following statement:

$$( {t}_{M} - {t}_{1} ) \times {M}_{total} / ( M - 1 ) > ( 1 / FPS ) ;$$

wherein Mₜₒₜₐₗ indicates the total number of packets that were transmitted out by said transmitting device in said payload of packets of encoded video data; wherein M indicates the index of the last packet, of said Video Payload, that was actually received at said recipient device, out of said Mₜₒₜₐₗ packets that were transmitted in said payload of packets of encoded video data; wherein t₁ indicates a time-of-arrival of a first packet out of said M packets of said payload of packets of encoded video data; wherein t_{M} indicates a time-of-arrival of a last packet that was received out of said M packets of said payload of packets of encoded video data; wherein FPS indicates a frames-per-second rate of said source video. In some embodiments, if said statement holds true, then the Bandwidth Estimation Method Selector operates to select the from-above estimate of Available Bandwidth and to discard the from-below estimate of Available Bandwidth; whereas, if said statement does not hold true, then the Bandwidth Estimation Method Selector operates to select the from-below estimate of Available Bandwidth and to discard the from-above estimate of Available Bandwidth.

In some embodiments, the transmitting device comprises a Forward Error Correction (FEC) encoder; wherein the FEC encoder of the transmitting device is configured (i) to protect with FEC encoding only said header of the payload of Mₜₒₜₐₗ packets of encoded video, and (ii) to not protect with FEC encoding any non-header portions of the payload of Mₜₒₜₐₗ packets of encoded video.

In some embodiments, the transmitting device comprises a Forward Error Correction (FEC) encoder; wherein the FEC encoder of the transmitting device is configured: (i) to protect with a first FEC encoding scheme, that provides a first level of data redundancy, the non-header portions of the payload of Mₜₒₜₐₗ packets of encoded video; (ii) to protect with a second, different, FEC encoding scheme, that provides a second, greater, level of data redundancy, the header of the payload of Mₜₒₜₐₗ packets of encoded video.

In some embodiments, the transmitting device is configured to enforce, when generating said payload of Mₜₒₜₐₗ packets of encoded video, a rule that a transmission time-duration of an entirety of said payload of Mₜₒₜₐₗ packets of encoded video of each frame, at an output point of the transmitting device, is smaller than 1/FPS, wherein FPS indicates a frames-per-second rate of the source video.

In some embodiments, the transmission time-duration of the entirety of the payload of Mₜₒₜₐₗ packets of encoded video is configured to be smaller than 1/FPS, by a particular margin; wherein said particular margin is selected such that the Bandwidth Estimation Method Selector selects the from-below estimate of Available Bandwidth, and to discard the from-above estimate of Available Bandwidth, at least 75 percent (or 66, or 70, or 80, or 85, or other suitable threshold value) of times in which both of said estimated values are available for selection by the Bandwidth Estimation Method Selector.

In some embodiments, the Available Bandwidth Estimator of the recipient device comprises: a Jitter Averaging Unit, configured to perform timing analysis of video-carrying packets from at least two different video frames that were transmitted from said transmitting device to said recipient device; wherein the Jitter Averaging Unit is configured to perform cross-frames collecting of video-carrying packets by selecting received video-carrying packets that are non-uniformly spread apart over time relative to a first packet of a respective video-frame.

In some embodiments, said Jitter Averaging Unit is an Adaptive Jitter Averaging Unit, configured to dynamically modify the number of video-carrying packets that are collected from said at least two different video frames, based on a calculated standard deviation of an error of slope estimation in a linear fit of analyzed data of packet-arrival time-points.

In some embodiments, the Bandwidth Estimator From Above of the recipient device, analyzes said transmission from the transmitting device to the recipient device, which consists exclusively of encoded video data that is intended for decoding into displayable video content; and which excludes any training data, and which excludes any non-video data that is utilized solely for bandwidth estimation and not for representing video intended for decoding and actual on-screen display.

In some embodiments, the Bandwidth Estimator From Below of the recipient device, analyzes the time-of-arrival of packets of said payload of up to Mₜₒₜₐₗ packets of encoded video data that were transmitted from the transmitting device to the recipient device; wherein said up to up to Mₜₒₜₐₗ packets consist exclusively of (I) encoded video data that is intended for decoding into on-screen displayable video content, and (II) said Header, and (III) Forward Error Correction (FEC) codes for protecting said Header and said video data, and (IV) encoded audio data, and (V) control data, and exclude any other overhead data, and exclude any training data, and exclude any non-video data that is utilized solely for bandwidth estimation and not for representing video intended for decoding and actual on-screen display.

In some embodiments, the Transmitting Device is configured to adaptively encode, in real time or in near-real-time, said source video which is a live video stream, into a best-available-quality encoded video based on the most-recent estimated value of Available Bandwidth of said communication link, dynamically and on-the-fly; without preparing and storing in advance multiple encoded versions of said source video; and without selecting one previously-encoded version of said source video out of a plurality of previously-encoded versions of said source video; and without encoding from said source video any encoded video frames that are not actually transmitted to said recipient device.

In some embodiments, the transmitting device comprises, or is operably connected to, a camera that captures video; wherein said source video is a live video and not a previously-recorded video; wherein said source video is encoded in real time or in near-real-time, immediately after video acquisition, at a video encoding bitrate that is adaptively determined based on a most-recently-estimated value of the Available Bandwidth of said communication link.

In some embodiments, the transmitting device integrally comprises a camera configured to capture said video data that is intended to be transmitted to said recipient device.

In some embodiments, the transmitting device is operably associated with an external and separate camera configured to capture said video data that is intended to be transmitted to said recipient device.

In some embodiments, the transmitting device is operably associated with an external video source that is configured to provide said video data that is intended to be transmitted to said recipient device.

In some embodiments, the transmitting device further comprises: a pre-transmission buffer, configured to store therein said payload of Mₜₒₜₐₗ packets of encoded video data that are already packetized and are ready for transmission; a pre-transmission sorting unit, configured to sort by packet-size the packets that are buffered in said pre-transmission buffer, in accordance with either an ascending packet size or a descending packet size.

In some embodiments, the transmitting device further comprises: (A) a pre-transmission buffer, configured to store therein said payload of Mₜₒₜₐₗ packets of encoded video data that are already packetized and are ready for transmission; (B) a pre-transmission sorting unit, configured to sort by packet-size the packets that are buffered in said pre-transmission buffer, in accordance with a descending packet size; wherein larger-size packets are outputted firstly from said pre-transmission buffer and are transmitted firstly from said transmitting device; wherein smaller-size packets are outputted lastly from said pre-transmission buffer and are transmitted lastly from said transmitting device; wherein the pre-transmission buffer is configured to output video packets therefrom, based on descending packet size, in a non-LIFO and non-FIFO and non-random buffer output scheme.

In some embodiments, the transmitting device further comprises: (A) a pre-transmission buffer, configured to store therein said payload of Mₜₒₜₐₗ packets of encoded video data that are already packetized and are ready for transmission; (B) a pre-transmission sorting unit, configured to sort by packet-size the packets that are buffered in said pre-transmission buffer, in accordance with an ascending packet size; wherein smaller-size packets are outputted firstly from said pre-transmission buffer and are transmitted firstly from said transmitting device; wherein larger-size packets are outputted lastly from said pre-transmission buffer and are transmitted lastly from said transmitting device; wherein the pre-transmission buffer is configured to output video packets therefrom, based on ascending packet size, in a non-LIFO and non-FIFO and non-random buffer output scheme.

In some embodiments, the Bandwidth Estimator From Below is configured to generate two or more values of from-below estimates of Available Bandwidth of said communication link; wherein the Bandwidth Estimation Method Selector is configured to: (i) firstly, select one particular from-below estimated value from the two or more values of from-below estimates of Available Bandwidth, based on a first set of selection rules; (ii) secondly, select one of: (I) said particular from-below estimated value of Available Bandwidth, or (II) said from-above estimated value of Available Bandwidth, based on a second set of selection rules.

In some embodiments, the recipient device is configured to perform bandwidth estimation (i) by ignoring, only for bandwidth estimation and not for video decoding, all incoming video packets that have a packet-size that is smaller than a pre-defined threshold value, and (ii) by modifying a resulting value of said bandwidth estimation to compensate for an estimated effect on bandwidth of the incoming video packets that were ignored.

Some embodiments provide a method comprising: transmitting video data from a transmitting device to a recipient device over a communication network having a non-fixed bandwidth; wherein the transmitting device and the receiving device have the respective functionality and/or components as described above, and/or are configured to perform the operations described above and/or herein.

Some embodiments provide a system having a transmitting device which comprises: (a) a transmitter configured to transmit packetized video data to the recipient device over one or more communication networks; (b) a pre-transmission buffer, configured to store therein a transmission burst comprising a group of video packets of encoded video data that are already packetized and are ready for transmission; (c) a pre-transmission sorting unit, configured to sort by packet-size the pre-transmission video packets that are buffered in said pre-transmission buffer, in accordance with a particular sorting order that is selected from the group consisting of: ascending packet size, descending packet size.

In some embodiments, the pre-transmission sorting unit is configured to sort by packet-size the pre-transmission video packets that are buffered in said pre-transmission buffer, in accordance with said particular sorting order that is descending packet size; wherein larger-size packets are outputted firstly from said pre-transmission buffer and are transmitted firstly from said transmitting device; wherein smaller-size packets are outputted lastly from said pre-transmission buffer and are transmitted lastly from said transmitting device; wherein the pre-transmission buffer is configured to output video packets therefrom, based on said particular sorting order that is descending packet size, in a non-LIFO and non-FIFO and non-random buffer output scheme.

In some embodiments, the pre-transmission sorting unit is configured to sort by packet-size the pre-transmission video packets that are buffered in said pre-transmission buffer, in accordance with said particular sorting order that is ascending packet size; wherein smaller-size packets are outputted firstly from said pre-transmission buffer and are transmitted firstly from said transmitting device; wherein larger-size packets are outputted lastly from said pre-transmission buffer and are transmitted lastly from said transmitting device; wherein the pre-transmission buffer is configured to output video packets therefrom, based on said particular sorting order that is ascending packet size, in a non-LIFO and non-FIFO and non-random buffer output scheme.

In some embodiments, the recipient device comprises a bandwidth estimation unit, that is configured to estimate an available bandwidth of a communication channel between the transmitting device and the recipient device, and is configured to ignore/discard, for bandwidth estimation and not for video decoding, any incoming video packets having a packet-size that is smaller than B bytes, wherein B is a pre-defined threshold value; wherein the bandwidth estimation unit of the recipient device is configured to perform estimation of said available bandwidth based exclusively on incoming video packets having a packet-size that is equal to or greater than B bytes; wherein the bandwidth estimation unit is configured to modify a resulting value of said bandwidth estimation to compensate for an estimated effect on bandwidth of the incoming video packets that were ignored due to having packet-size smaller than B bytes.

Some embodiments provide a system having a receiving device which comprises: (a) a receiver configured to receive packetized video data from a transmitting device over one or more communication networks; (b) a de-packetizing unit, configured to de-packetize the incoming packetized video data, and to generate decoded video (e.g., to generate video data that is not divided into packets; but rather, for example, is represented by video frames); and (c) a bandwidth estimation unit, configured to estimate an available bandwidth of a communication channel between the transmitting device and the recipient device, and configured to ignore/discard, for bandwidth estimation and not for video decoding, any incoming video packets having a packet-size that is smaller than B bytes, wherein B is a pre-defined threshold value; wherein the bandwidth estimation unit is configured to modify a resulting value of said bandwidth estimation to compensate for an estimated effect on bandwidth of the incoming video packets that were ignored due to having packet-size smaller than B bytes; wherein the bandwidth estimation unit performs estimation of said available bandwidth based exclusively on incoming video packets having a packet-size that is equal to or greater than B bytes. In some embodiments, the bandwidth estimation unit comprises: (I) a first bandwidth estimation module, configured to estimate said available bandwidth by utilizing a first bandwidth estimation process, and to generate a first bandwidth estimation value; (II) a second bandwidth estimation module, configured to estimate said available bandwidth by utilizing a second, different, bandwidth estimation process, and to generate a second bandwidth estimation value; (III) a bandwidth estimation selector unit, configured to select and to utilize one of: the first bandwidth estimation value, and the second bandwidth estimation value, based on one or more pre-defined selection rules.

In a demonstrative implementation of a system that is capable of estimating the available bandwidth, there is a video transmitter sending video payload to a video receiver, over the Internet or over TCP/IP or over UDP or over other medium. The Applicant has realized that video packets—of a single video frame, and/or of various/consecutive/non-consecutive video frames—are not necessarily of equal size (in bytes, or in bits); and that the total size (e.g., in bytes, or in bits) of a single video frame may be a prime number (e.g., 9,323 bytes, such that it cannot be divided into packets of equal size), and/or that the total size (e.g., in bytes, or in bits) of a single frame is non-prime but does not conveniently divide (without a remainder) into packets having a desired size (for example, a video frame having a size of 8,633 bytes, which has two prime factors: 89 and 97; such that it can be divided only to 89 packets of 97-byte each, or into 97 packets of 89-bytes each, and no other combination of equal-sized packets). Indeed, some implementations may attempt to maintain a constant packet size, such as by padding with zeros a last packet of a video frame, but this may cause inefficient utilization of available bandwidth; or by shortening one or more of the last systematic packets, but this (by itself) may sometimes reduce or degrade the accuracy of the estimation of the available bandwidth.

The Applicant has realized that in some situations, when transmitting some packets that are shorter than others, or when transmitting packets of non-constant size, the polyfit method described above may sometimes experience a slight distortion which may increase with the magnitude of the packet-size shortening. For example, the shortest packet-size may be as small as 8 or 10 bytes; whereas the largest packet-size may be 1,400 or 1,500 bytes. In some implementations, the polyfit may assume a model of uniform packet handling time at the network with the addition of some jitter; however, realized the Applicant, when the packet size is small (e.g., below a pre-defined threshold value), the handling time at the network is shorter as well; and the polyfit results may be distorted or skewed or biased due to the shorter-size packets.

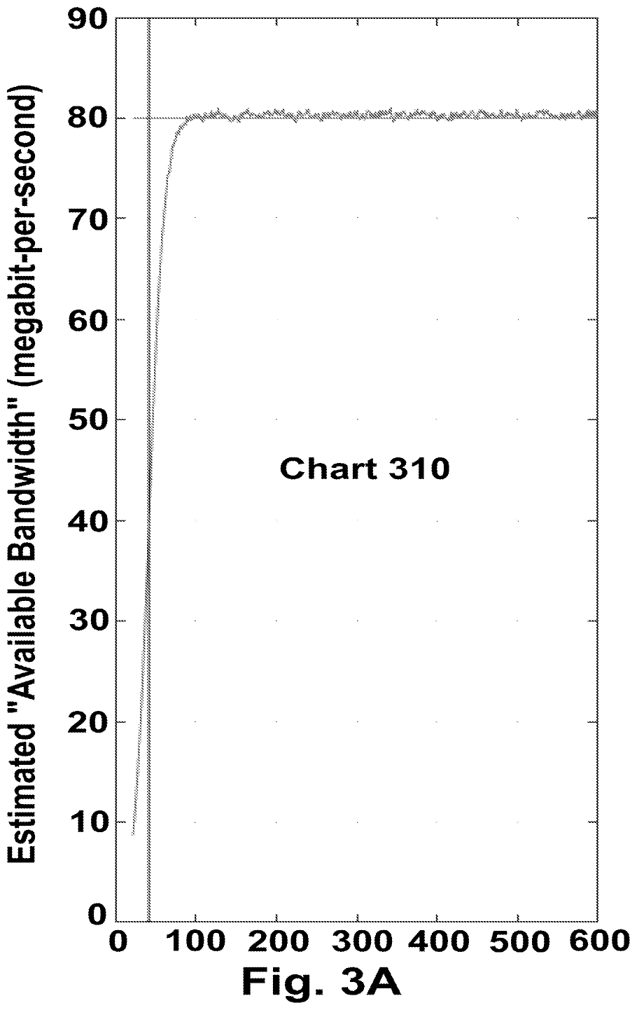

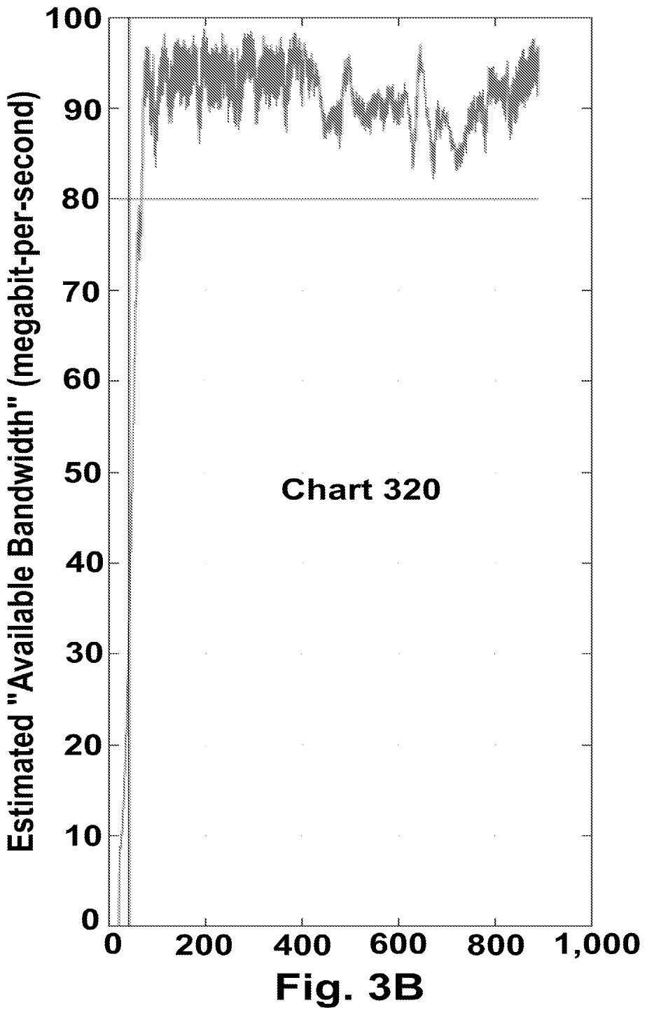

Reference is made to FIG. 3A, which is an illustration of a chart 310 demonstrating bandwidth estimation performed on a video transmission in which all packets have equal (constant, uniform) size, and when the actual bandwidth is 80 megabit-per-second, in accordance with some embodiments. The Y axis (vertical axis) indicates the value of the estimated available bandwidth; the X axis (horizontal axis) may indicate the sequence number of video frames (or, in some implementations, may indicate the sequence number of video packets). As shown, the values of the estimated available bandwidth are generally steady and closely track the horizontal line of 80 megabit-per-second, without significant fluctuations.

Reference is made to FIG. 3B, which is an illustration of a chart 320 demonstrating bandwidth estimation performed on a video transmission in which not all packets have equal/constant/uniform size, and when the actual bandwidth is 80 megabit-per-second, in accordance with some embodiments. The Y axis (vertical axis) indicates the value of the estimated available bandwidth; the X axis (horizontal axis) may indicate the sequence number of video frames (or, in some implementations, may indicate the sequence number of video packets). In a demonstrative example, some of the video packets are shorter than the other video packets; such as, 90 or 95 percent of the transmitted video packets have a constant size of N bytes, and the other 10 or 5 percent (respectively) of the transmitted video packets (which are typically non-consecutive, and are typically scattered among the other 90 or 95 percent (respectively) of transmitted video packets) have various sizes that are shorter than a pre-defined threshold (e.g., each such “shorter packet” is not more than N/2 or N/3 or N/4 bytes per packet; wherein N is the constant size of the equal-sized packets). As shown, the values of the estimated available bandwidth are fluctuating and are generally non-steady, they do not closely track the horizontal line of 80 megabit-per-second; rather, they demonstrate significant fluctuations ranging between 83 to 98 megabit-per-second, and their average value appears to be around 90 megabit-per-second, which is approximately 12 percent above the actual bandwidth of 80 megabit-per-second.

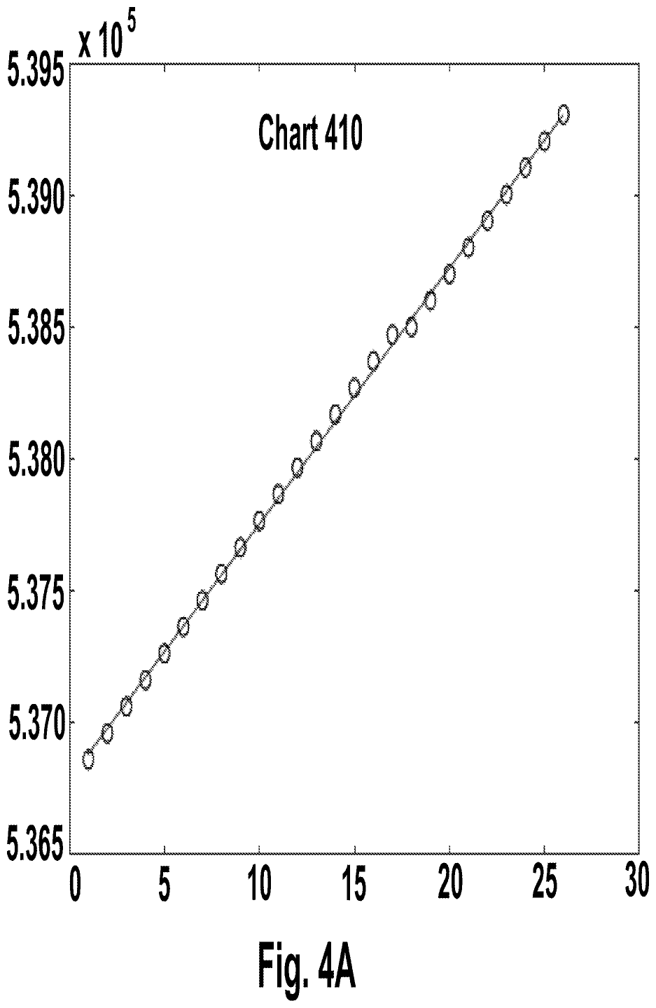

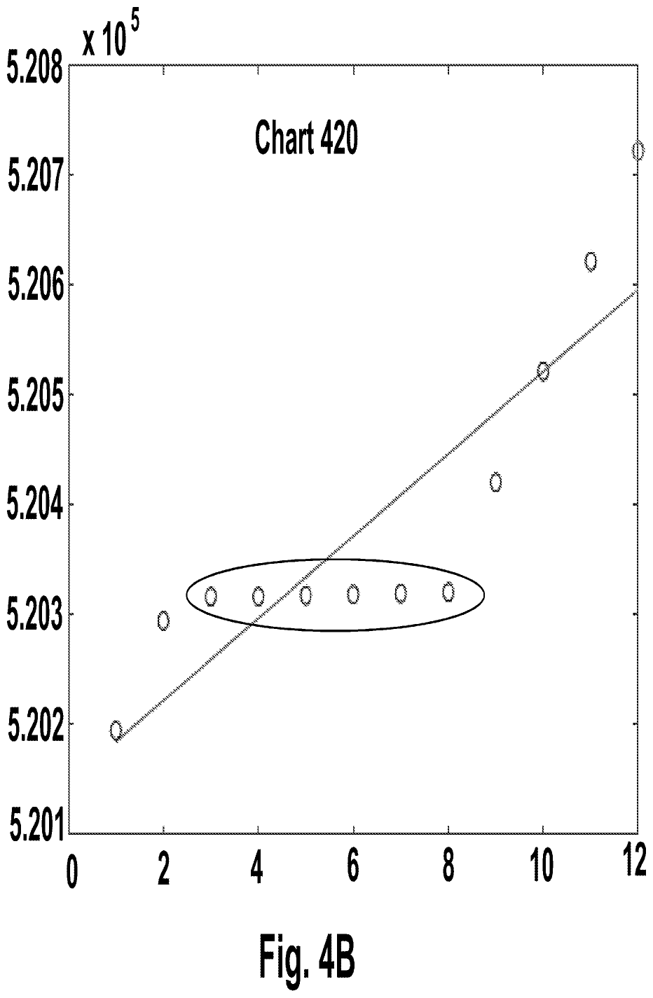

Reference is made to FIG. 4A, which is an illustration of a chart 410 demonstrating a polyfit result corresponding to the bandwidth estimation values of chart 310 of FIG. 3A, wherein all packets have equal (constant, uniform) size, in accordance with some embodiments. As demonstrated, a diagonal line of the polyfit result tracks closely/tightly all the data-points in the chart.

Reference is made to FIG. 4B, which is an illustration of a chart 420 demonstrating a polyfit result corresponding to the bandwidth estimation values of chart 420 of FIG. 3B, wherein not all packets have equal (constant, uniform) size, in accordance with some embodiments. As demonstrated, a diagonal line of the polyfit result does not closely/tightly track all the data-points in the chart; two left-most data-points and four right-most data-points (which correspond to constant-size packets) are diagonally slanted upwardly and to the right, whereas six data-points between these two regions (which correspond to shorter-size packets, and are shown surrounded by an elongated oval) are arranged almost horizontally; and this causes the diagonal line of the polyfit result to be slanted differently (e.g., to be less slanted, in this example) relative to the diagonal line of the polyfit result in chart 410.

The Applicant has realized that the polyfit results may be improved, and/or that the bandwidth estimation may be improved, by re-ordering the video packets intended for transmission, or the pre-transmission video packets that were already generated (packetized) and that are waiting to be transmitted or that are about to be transmitted or that are temporarily buffered/queued in a pre-transmission buffer/queue of ready-to-transmit video packets.

In a first set of embodiments, a pre-transmission buffer of video packets may be sorted or re-arranged or re-ordered, pre-transmission and at the transmitting device, such that smaller-sized video packets (e.g., of a single frame; or of F frames, wherein F is 1 or 2 or 3 or 4 of 6 or 8, or wherein F is in the range of 1 to 8; or of P packets, wherein P is an integer in the range of 12 packets to 180 packets) are moved to the end of the pre-transmission buffer (and are thus transmitted lastly), and such that the larger-size packets (including the uniform size packets having the largest size) are moved to the beginning of the pre-transmission buffer (and are thus transmitted firstly); and such particular sorting and re-ordering, by packet size (in bytes, or in bits) in descending order (from the largest-size packet at the beginning of the pre-transmission buffer for earlier transmission, to the smallest-size packet at the end of the pre-transmission buffer for later transmission) may yield a better polyfit result (and thus a more accurate generation of the estimated available bandwidth), as the polyfit process may ignore (or, may attribute a smaller weight to, or may attribute a smaller skewing bias to) the smaller-size packets that are now at the end of the data-points; and the data-points corresponding to such smaller-size packets, being located at the end of the set of data-points, causes a smaller negative effect on the accuracy of the polyfit for bandwidth estimation, compared to a scenario in which such smaller-size packets are scattered among the uniform-size packets or compared to a scenario in which such smaller-size packets are grouped (in one group, or in several groups) within the uniform-sized packets.

In a second set of embodiments, a pre-transmission buffer of video packets may be sorted or re-arranged or re-ordered, pre-transmission and at the transmitting device, such that smaller-sized video packets (e.g., of a single frame; or of F frames, wherein F is 1 or 2 or 3 or 4 of 6 or 8, or wherein F is in the range of 1 to 8; or of P packets, wherein P is an integer in the range of 12 packets to 180 packets) are moved to the beginning of the pre-transmission buffer (and are thus transmitted firstly), and such that the larger-size packets (including the uniform size packets having the largest size) are moved to the end of the pre-transmission buffer (and are thus transmitted lastly); and such particular sorting and re-ordering, by packet size (in bytes, or in bits) in ascending order (from the smallest-size packet at the beginning of the pre-transmission buffer for earlier transmission, to the largest-size packet at the end of the pre-transmission buffer for later transmission) may yield a better polyfit result (and thus a more accurate generation of the estimated available bandwidth), as the polyfit process may ignore (or, may attribute a smaller weight to, or may attribute a smaller skewing bias to) the smaller-size packets that are now at the beginning of the data-points; and the data-points corresponding to such smaller-size packets, being located at the beginning of the set of data-points, causes a smaller negative effect on the accuracy of the polyfit for bandwidth estimation, compared to a scenario in which such smaller-size packets are scattered among the uniform-size packets or compared to a scenario in which such smaller-size packets are grouped (in one group, or in several groups) within the uniform-sized packets.

Referring again to FIG. 1, there are shown a Pre-Transmission Buffer 141 configured to store already-generated video packets that are intended for transmission; and an associated Buffer Re-Ordering Unit 142 configured to sort/re-order/re-arrange the already-generated packets within that Pre-Transmission Buffer 141, based on packet size (in bytes, or in bits), either in a descending packet-size order (larger video packets of would be transmitted firstly) or, in some implementations, in an ascending packet-size order (smaller video packets would be transmitted firstly). The Pre-Transmission Buffer 141 may store, and the Buffer Re-Ordering Unit 142 may sort/re-order/re-arrange, a total of P packets; wherein P may be, for example, in the range of 12 to 180; or P may be in the range of 16 to 144; or P may be in the range of 8 to 256; or P may correspond to the total number of packets of a single video frame; or P may correspond to the total number of packets of 2 video frames; or P may correspond to the total number of packets of 3 video frames; or P may correspond to the total number of packets of 4 video frames; or P may correspond to the total number of packets of 6 video frames; or P may correspond to the total number of packets of 8 video frames; or P may correspond to the total number of packets of 2 to 4 video frames; or P may correspond to the total number of packets of 2 to 8 video frames; or P may correspond to the total number of packets of 4 to 8 video frames; or P may correspond to the total number of packets in a “transmission burst”, namely, a set of already-generated video packets that are ready to be sent and that are considered a “ready to transmit” group based on one or more other selection criteria, or based on a triggering event or a triggering condition that dictates that a group of already-generated video packets should be transmitted.

For demonstrative purposes, Pre-Transmission Buffer 141 and Buffer Re-Ordering Unit 142 are shown as part of the Transmitting Device 110. However, other implementations may be provided; for example, Pre-Transmission Buffer 141 and Buffer Re-Ordering Unit 142 may be internal to the transmitting device, or may be co-located with it or near it, or may even be (in some implementations) external and/or remote to the transmitting device and/or may be implemented as a separate unit or separate device; or may be implemented on the communication route from the packet generation unit/packetization unit to the transmitter or to a UDP socket or to a TCP/IP socket; or may even be implemented between the transmitter 113 of the Transmitting Device 110 and another (e.g., external/remote/separate) relay unit or re-transmitter unit or communication router.

In some embodiments, the level of variance in the size of packets that belong to a single “transmission burst” group-of-packets, may be a function of the video frame or video frames that are being encoded and packetized; and/or may be a function of the content depicted in such video frame(s). In some embodiments, optionally, the Payload Generator 117 may include or may be associated with a Packetization Unit, which may optionally be configured to generate video packets in accordance with Packet Size Generation Rules; for example, such that a dominant majority of the generated video packets (e.g., at least 85 or 90 or 95 percent of the generated video packets) would have a uniform size (in bytes, or in bits) that is greater than a pre-defined threshold value (e.g., the threshold value being, for example, 512 bytes or 640 bytes, or 720 bytes or 800 bytes or 880 bytes; or the threshold value being in the range of 500 to 1,000 bytes; or the threshold value being in the range of 512 to 1,024 bytes), and such that a significant minority of the generated video packets (e.g., not more than 15 or 10 or 5 percent of the generated video packets) would have a size that is smaller than said uniform size. In some embodiments, the total number of pre-transmission video packets that are pre-transmission buffered and are pre-transmission sorted based on packet size (in ascending order, or in descending order) is in the range of 12 packets to 180 packets; whereas, the total number of shorter packets (e.g., the packets that do not have the uniform, large, packet size) in such batch or packets or “transmission burst” can be 1 or 2 or 3 or 4 or 5 or 6 or 7 or 8, or can be in the range of 1 to 8 or in the range of 2 to 8 or in the range of 2 to 6 or in the range of 4 to 8 or in the range of 4 to 6.

In some embodiments, if two (or more) pre-transmission video packets have the same size (in bytes, or in bits), then: they can be placed/re-ordered within the Pre-Transmission Buffer 141 based on packet ID/packet sequence number; or based on other pre-defined sorting/re-ordering condition.

It is noted that the sorting/re-ordering of the pre-transmission packets buffer, causes that buffer to output video packets in accordance with a non-LIFO and non-FIFO and non-random scheme (e.g., a scheme that does not employ Last In First Out, and does not employ First In First Out, and does not employ random or pseudo-random output of packet(s) from the buffer); namely, an output scheme and a transmission scheme, of video packets, that relies on the particular re-ordering/sorting based on Packet Size (in bytes or in bits) within such pre-transmission buffer.

In accordance with some embodiments, the Recipient Device 120 is capable of correctly handling the incoming video packets, even if they arrive out-of-order; since a reception buffer/jitter buffer/re-ordering unit/de-packetizing unit at the Recipient Device 120 operates to buffer and re-arrange the incoming video packets based on packet ID/packet sequence number. Then, the bandwidth estimation units (114R, 115R) at the Recipient Device 120 may discard or ignore—only for Bandwidth Estimation purposes, not for video decoding purposes—the smaller-size packets in the incoming burst; and the bandwidth estimation units (114R, 115R) at the Recipient Device 120 may utilize only the larger-size, uniform-size, video packets for Bandwidth Estimation purposes; thereby overcoming a possible mis-fit or skew or bias which may arise (in some situations) due to smaller-size packets being scattered within a group of uniform-size packets. It is also noted that the re-ordering or the permutation of the buffered pre-transmission video packets, performed at the transmitting device side, can be calculated or estimated at the receiving device side from a small number of packets (e.g., from 4 or 6 or 8 packets), and may be utilized for synchronization purposes that are not related to the bandwidth estimation process.

In another set of embodiments, optionally, pre-transmission re-ordering of buffered and ready-to-transmit video packets is not performed at all at the transmitting device; and rather, the bandwidth estimation units (114R, 115R) at the Recipient Device 120 may be configured to discard or ignore—only for Bandwidth Estimation purposes, not for video decoding purposes—the smaller-size packets in the incoming burst (e.g., to ignore or discard, for bandwidth estimation purposes, any incoming video packet having a size smaller than B bytes or bits; such as, smaller than 512 bytes, or smaller than 256 bytes, or smaller than 128 bytes, or smaller than 64 bytes; or, smaller than the average size of the most-recent P packets, wherein P is 32 or 64 or 128 or other pre-defined number). In some embodiments, optionally, the bandwidth estimation unit(s) and process may be configured to take into account the fact that some small-size packets were ignored or discarded in the bandwidth estimation process, and/or to take into account the fact that the bandwidth estimation process was applied only on uniform-size/constant-size packets, and/or to take into account the fact that the bandwidth estimation process was applied only on packets having a packet-size of at least B bytes (wherein B is a pre-defined value; for example, 900 or 1,200 or 1,450 bytes), and/or to otherwise modify the result of the bandwidth estimation process to compensate for the fact that small-size packets/non-uniform-size packets were ignored or discarded in the bandwidth estimation process.

In a demonstrative example of such possible compensation scheme, the system may monitor and count the ratio of uniform-size packets to small-size/non-constant-size packets, and may determine that over a large number of transmitted packets (e.g., when monitoring a total of 1 million packets), the ratio is (for example) 97 to 3, such that there are (on average) 3 smaller-size packets for every 97 uniform-size (large) packets. In this demonstrative example, the system may also monitor and determine that the average size of the smaller-size packets is (for example) one-half of the size of a uniform-size packets. Therefore, if the size of a uniform-size packet is U bytes; the average size of a smaller-size packet is U/2; the total size in bytes of the 97 uniform-size packets is 97 U; the total size in bytes of the 3 smaller-size packets is estimated to be 3 U/2; the total size in bytes of the uniform packets and the non-uniform packets is 97 U+3 U/2, which is 101.5 U; and this size (101.5 U) is greater than the size of the non-ignored uniform-size packets (97U) by 101.5/97, which is approximately 4.6 percent; namely, the actual bandwidth value can be compensated to be 4.6 percent greater than the result of the bandwidth estimation process that had ignored/discarded the smaller-size/non-uniform-size packets. The above is only one demonstrative example for such compensation scheme; other and/or additional compensation rules may be utilized in some embodiments.

Some embodiments provide a non-transitory storage medium having stored thereon instructions that, when executed by a machine, cause the machine to perform the method described above and/or one or more of the operations described above.

Some embodiments provide systems, devices, and methods of video encoding and video transmission using improved estimation of available bandwidth. For example, a transmitting device is configured to transmit video data to a recipient device over a communication network having a non-fixed bandwidth. A configurable video encoder encodes a source video into an encoded video. An Available Bandwidth Estimator operates at the recipient device, to estimate a currently-available bandwidth of the communication channel. Two different bandwidth estimation methods are used at the recipient device, and one of two estimated values is then selected based on pre-defined selection rules. Video encoding parameters that are used by the configurable video encoder of the transmitting device are dynamically modified based on the most-recent estimate of the currently-available bandwidth of the communication channel. Optionally, pre-transmission packets are sorted in a pre-transmission buffer at the transmitting device, based on packet size, to improve accuracy of bandwidth estimation.

Although portions of the discussion herein relate, for demonstrative purposes, to wired links and/or wired communications, some embodiments are not limited in this regard, but rather, may utilize wired communication and/or wireless communication; may include one or more wired and/or wireless links; may utilize one or more components of wired communication and/or wireless communication; and/or may utilize one or more methods or protocols or standards of wireless communication.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL), BASIC, Visual BASIC, MATLAB, Pascal, HTML, HTML5, CSS, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may be used in, or in conjunction with, various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a tablet, an on-board device, an off-board device, a hybrid device, a vehicular device, a non-vehicular device, a mobile or portable device, a consumer device, a non-mobile or non-portable device, an appliance, a wireless communication station, a wireless communication device, a wireless Access Point (AP), a wired or wireless router or gateway or switch or hub, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), or the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA or handheld device which incorporates wireless communication capabilities, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may comprise, or may be implemented by using, an “app” or application which may be downloaded or obtained from an “app store” or “applications store”, for free or for a fee, or which may be pre-installed on a computing device or electronic device, or which may be otherwise transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may thus comprise any possible or suitable combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some demonstrative embodiments of the present invention have been illustrated and described herein, various modifications, substitutions, changes, and equivalents may occur to those skilled in the art. Accordingly, the claims are intended to cover all such modifications, substitutions, changes, and equivalents.

1. A system comprising:
a transmitting device and a recipient device,
wherein the transmitting device is configured to transmit video data to the recipient device over a communication network having a non-fixed bandwidth;
wherein the recipient device is operably communicative with said communication network over a communication link having a non-fixed bandwidth of R bits-per-second, wherein R is varying over time;
wherein the recipient device comprises: an Available Bandwidth Estimator, to estimate a currently-available bandwidth of said communication link between said communication network and said recipient device;
wherein the Available Bandwidth Estimator of the recipient device comprises:
(a1) a Bandwidth Estimator From Above, configured to generate a from-above estimate of Available Bandwidth of said communication link, based on a first analysis performed by the recipient device which divides (i) the total number of bits which arrived during a certain time interval by (ii) the duration of that time interval; wherein a size in bits of each frame is conveyed from the transmitting device to the recipient device;
(a2) a Bandwidth Estimator From Below, configured to generate a from-below estimate of Available Bandwidth of said communication link, based on a second, different, analysis performed by the recipient device which analyzes time-of-arrival of packets from a set of Mₜₒₜₐₗ packets of encoded video data that was transmitted from the transmitting device to the recipient device, wherein said payload of Mₜₒₜₐₗ packets of encoded video data were transmitted by the transmitting device;
wherein a header of said payload of Mₜₒₜₐₗ packets of encoded video, stores at least one of: (i) the value of Mₜₒₜₐₗ, (ii) the total size in bits of said payload of Mₜₒₜₐₗ packets of encoded video;
(a3) a Bandwidth Estimation Method Selector, configured to dynamically select, from time to time, based on a pre-defined set of selection rules, either (i) the from-above estimate of Available Bandwidth, or (ii) the from-below estimate of Available Bandwidth, as a currently-estimated Available Bandwidth value that should be utilized for modification of video encoding parameters at the transmitting device;
wherein the recipient device comprises a transmitter that is configured to periodically transmit, from the recipient device to the transmitting device, a message indicating a current value of the currently-available bandwidth as estimated by the Available Bandwidth Estimator of the recipient device;
wherein the transmitting device comprises:
(b1) a configurable video encoder, that encodes a source video into encoded video data;
(b2) an Encoding Parameters Modification Unit, to dynamically configure said configurable video encoder to dynamically generate said encoded video data by using a video encoding bitrate that is lower than 95 percent of the current value of the currently-available bandwidth as estimated by the Available Bandwidth Estimator of the recipient device.

2. The system of claim 1,
wherein the payload of Mₜₒₜₐₗ packets of encoded video data comprises Mₜₒₜₐₗ packets for each video frame of the encoded video data.

3. The system according to claim 1,
wherein the payload of Mₜₒₜₐₗ packets of encoded video data comprises Mₜₒₜₐₗ packets for each video frame of the encoded video data;
wherein the payload of Mₜₒₜₐₗ packets of encoded video data is generated at the transmitting device to consist of exactly B bits;
wherein B is calculated by the transmitting device as B=R3/FPS;
wherein FPS indicates the frames-per-second rate of the source video;
wherein R3 is selected by the transmitting device to have a value that is up to 90% of the most-recently-estimated value of R.

4. The system according to claim 3,
wherein the Bandwidth Estimation Method Selector applies the following set of selection rules:
check a validity of the following statement:
$$( {t}_{M} - {t}_{1} ) \times {M}_{total} / ( M - 1 ) > ( 1 / FPS ) ;$$
wherein Mₜₒₜₐₗ indicates the total number of packets that were transmitted out by said transmitting device in said payload of packets of encoded video data;
wherein M indicates the index of the last packet, of said Video Payload, that was actually received at said recipient device, out of said Mₜₒₜₐₗ packets that were transmitted in said payload of packets of encoded video data;
wherein t₁ indicates a time-of-arrival of a first packet out of said M packets of said payload of packets of encoded video data;
wherein t_{M} indicates a time-of-arrival of a last packet that was received out of said M packets of said payload of packets of encoded video data;
wherein FPS indicates a frames-per-second rate of said source video;
wherein,
if said statement holds true, then the Bandwidth Estimation Method Selector operates to select the from-above estimate of Available Bandwidth and to discard the from-below estimate of Available Bandwidth;
if said statement does not hold true, then the Bandwidth Estimation Method Selector operates to select the from-below estimate of Available Bandwidth and to discard the from-above estimate of Available Bandwidth.

5. The system according to claim 1,
wherein the transmitting device comprises a Forward Error Correction (FEC) encoder;
wherein the FEC encoder of the transmitting device is configured (i) to protect with FEC encoding only said header of the payload of Mₜₒₜₐₗ packets of encoded video, and (ii) to not protect with FEC encoding any non-header portions of the payload of Mₜₒₜₐₗ packets of encoded video.

6. The system according to claim 1,
wherein the transmitting device comprises a Forward Error Correction (FEC) encoder;
wherein the FEC encoder of the transmitting device is configured
(i) to protect with a first FEC encoding scheme, that provides a first level of data redundancy, the non-header portions of the payload of Mₜₒₜₐₗ packets of encoded video;
(ii) to protect with a second, different, FEC encoding scheme, that provides a second, greater, level of data redundancy, the header of the payload of Mₜₒₜₐₗ packets of encoded video.

7. The system according to claim 1,
wherein the transmitting device is configured to enforce, when generating said payload of Mₜₒₜₐₗ packets of encoded video, a rule that a transmission time-duration of an entirety of said payload of Mₜₒₜₐₗ packets of encoded video of each frame, at an output point of the transmitting device, is smaller than 1/FPS,
wherein FPS indicates a frames-per-second rate of the source video.

8. The system of claim 7,
wherein the transmission time-duration of the entirety of the payload of Mₜₒₜₐₗ packets of encoded video is configured to be smaller than 1/FPS, by a particular margin,
wherein said particular margin is selected such that the Bandwidth Estimation Method Selector selects the from-below estimate of Available Bandwidth, and to discard the from-above estimate of Available Bandwidth, at least 75 percent of times in which both of said estimated values are available for selection by the Bandwidth Estimation Method Selector.

9. The system according to claim 1,
wherein the Available Bandwidth Estimator of the recipient device comprises:
a Jitter Averaging Unit, configured to perform timing analysis of video-carrying packets from at least two different video frames that were transmitted from said transmitting device to said recipient device;
wherein the Jitter Averaging Unit is configured to perform cross-frames collecting of video-carrying packets by selecting received video-carrying packets that are non-uniformly spread apart over time relative to a first packet of a respective video-frame.

10. The system of claim 9,
wherein said Jitter Averaging Unit is an Adaptive Jitter Averaging Unit, configured to dynamically modify the number of video-carrying packets that are collected from said at least two different video frames, based on a calculated standard deviation of an error of slope estimation in a linear fit of analyzed data of packet-arrival time-points.

11. The system according to claim 1,
wherein the Bandwidth Estimator From Above of the recipient device,
analyzes said transmission from the transmitting device to the recipient device,
which consists exclusively of encoded video data that is intended for decoding into displayable video content,
and which excludes any training data,
and which excludes any non-video data that is utilized solely for bandwidth estimation and not for representing video intended for decoding and actual on-screen display.

12. The system according to claim 1,
wherein the Bandwidth Estimator From Below of the recipient device,
analyzes the time-of-arrival of packets of said payload of up to Mₜₒₜₐₗ packets of encoded video data that were transmitted from the transmitting device to the recipient device,
wherein said up to Mₜₒₜₐₗ packets consist exclusively of (I) encoded video data that is intended for decoding into on-screen displayable video content, and (II) said Header, and (III) Forward Error Correction (FEC) codes for protecting said Header and said video data, and (IV) encoded audio data, and (V) control data,
and exclude any other overhead data, and exclude any training data,
and exclude any non-video data that is utilized solely for bandwidth estimation and not for representing video intended for decoding and actual on-screen display.

13. The system according to claim 1,
wherein the Transmitting Device is configured to adaptively encode, in real time or in near-real-time, said source video which is a live video stream, into a best-available-quality encoded video based on the most-recent estimated value of Available Bandwidth of said communication link, dynamically and on-the-fly,
without preparing and storing in advance multiple encoded versions of said source video,
and without selecting one previously-encoded version of said source video out of a plurality of previously-encoded versions of said source video,
and without encoding from said source video any encoded video frames that are not actually transmitted to said recipient device.

14. The system according to claim 1,
wherein the transmitting device comprises, or is operably connected to, a camera that captures video;
wherein said source video is a live video and not a previously-recorded video;
wherein said source video is encoded in real time or in near-real-time, immediately after video acquisition, at a video encoding bitrate that is adaptively determined based on a most-recently-estimated value of the Available Bandwidth of said communication link.

15. The system according to claim 1,
wherein the transmitting device integrally comprises a camera configured to capture said video data that is intended to be transmitted to said recipient device.

16. The system according to claim 1,
wherein the transmitting device is operably associated with an external and separate camera configured to capture said video data that is intended to be transmitted to said recipient device.

17. The system according to claim 1,
wherein the transmitting device is operably associated with an external video source that is configured to provide said video data that is intended to be transmitted to said recipient device.

18. The system according to claim 1,
wherein the transmitting device further comprises:
a pre-transmission buffer, configured to store therein said payload of Mₜₒₜₐₗ packets of encoded video data that are already packetized and are ready for transmission;
a pre-transmission sorting unit, configured to sort by packet-size the packets that are buffered in said pre-transmission buffer, in accordance with either an ascending packet size or a descending packet size.

19. The system according to claim 1,
wherein the transmitting device further comprises:
(A) a pre-transmission buffer, configured to store therein said payload of Mₜₒₜₐₗ packets of encoded video data that are already packetized and are ready for transmission;
(B) a pre-transmission sorting unit, configured to sort by packet-size the packets that are buffered in said pre-transmission buffer, in accordance with a descending packet size,
wherein larger-size packets are outputted firstly from said pre-transmission buffer and are transmitted firstly from said transmitting device,
wherein smaller-size packets are outputted lastly from said pre-transmission buffer and are transmitted lastly from said transmitting device;
wherein the pre-transmission buffer is configured to output video packets therefrom, based on descending packet size, in a non-LIFO and non-FIFO and non-random buffer output scheme.

20. The system according to claim 1,
wherein the transmitting device further comprises:
(A) a pre-transmission buffer, configured to store therein said payload of Mₜₒₜₐₗ packets of encoded video data that are already packetized and are ready for transmission;
(B) a pre-transmission sorting unit, configured to sort by packet-size the packets that are buffered in said pre-transmission buffer, in accordance with an ascending packet size,
wherein smaller-size packets are outputted firstly from said pre-transmission buffer and are transmitted firstly from said transmitting device,
wherein larger-size packets are outputted lastly from said pre-transmission buffer and are transmitted lastly from said transmitting device;
wherein the pre-transmission buffer is configured to output video packets therefrom, based on ascending packet size, in a non-LIFO and non-FIFO and non-random buffer output scheme.

21. The system according to claim 1,
wherein the Bandwidth Estimator From Below is configured to generate two or more values of from-below estimates of Available Bandwidth of said communication link;
wherein the Bandwidth Estimation Method Selector is configured to
(i) firstly, select one particular from-below estimated value from the two or more values of from-below estimates of Available Bandwidth, based on a first set of selection rules;
(ii) secondly, select one of: (I) said particular from-below estimated value of Available Bandwidth, or (II) said from-above estimated value of Available Bandwidth, based on a second set of selection rules.

22. The system according to claim 1,
wherein the recipient device is configured to perform bandwidth estimation (i) by ignoring, only for bandwidth estimation and not for video decoding, all incoming video packets that have a packet-size that is smaller than a pre-defined threshold value, and (ii) by modifying a resulting value of said bandwidth estimation to compensate for an estimated effect on bandwidth of the incoming video packets that were ignored.

23. A method comprising:
transmitting video data from a transmitting device to a recipient device over a communication network having a non-fixed bandwidth;
wherein the recipient device is operably communicative with said communication network over a communication link having a non-fixed bandwidth of R bits-per-second, wherein R is varying over time;
wherein the recipient device comprises: an Available Bandwidth Estimator, to estimate a currently-available bandwidth of said communication link between said communication network and said recipient device;
wherein the Available Bandwidth Estimator of the recipient device comprises:
(a1) a Bandwidth Estimator From Above, configured to generate a from-above estimate of Available Bandwidth of said communication link, based on a first analysis performed by the recipient device which divides (i) the total number of bits which arrived during a certain time interval by (ii) the duration of that time interval; wherein a size in bits of each frame is conveyed from the transmitting device to the recipient device;
(a2) a Bandwidth Estimator From Below, configured to generate a from-below estimate of Available Bandwidth of said communication link, based on a second, different, analysis performed by the recipient device which analyzes time-of-arrival of packets from a set of Mₜₒₜₐₗ packets of encoded video data that was transmitted from the transmitting device to the recipient device, wherein said payload of Mₜₒₜₐₗ packets of encoded video data were transmitted by the transmitting device;
wherein a header of said payload of Mₜₒₜₐₗ packets of encoded video, stores at least one of: (i) the value of Mₜₒₜₐₗ, (ii) the total size in bits of said payload of Mₜₒₜₐₗ packets of encoded video;
(a3) a Bandwidth Estimation Method Selector, configured to dynamically select, from time to time, based on a pre-defined set of selection rules, either (i) the from-above estimate of Available Bandwidth, or (ii) the from-below estimate of Available Bandwidth, as a currently-estimated Available Bandwidth value that should be utilized for modification of video encoding parameters at the transmitting device;
wherein the recipient device comprises a transmitter that is configured to periodically transmit, from the recipient device to the transmitting device, a message indicating a current value of the currently-available bandwidth as estimated by the Available Bandwidth Estimator of the recipient device;
wherein the transmitting device comprises:
(b1) a configurable video encoder, that encodes a source video into encoded video data;
(b2) an Encoding Parameters Modification Unit, to dynamically configure said configurable video encoder to dynamically generate said encoded video data by using a video encoding bitrate that is lower than 95 percent of the current value of the currently-available bandwidth as estimated by the Available Bandwidth Estimator of the recipient device.

24. (canceled)

25. A system comprising:
a transmitting device comprising:
(a) a transmitter configured to transmit packetized video data to a recipient device over one or more communication networks;
(b) a pre-transmission buffer, configured to store therein a transmission burst comprising a group of video packets of encoded video data that are already packetized and are ready for transmission;
(c) a pre-transmission sorting unit, configured to sort by packet-size the pre-transmission video packets that are buffered in said pre-transmission buffer, in accordance with a particular sorting order that is selected from the group consisting of: ascending packet size, descending packet size.

26. The system of claim 25,
wherein the pre-transmission sorting unit is configured to sort by packet-size the pre-transmission video packets that are buffered in said pre-transmission buffer, in accordance with said particular sorting order that is descending packet size;
wherein larger-size packets are outputted firstly from said pre-transmission buffer and are transmitted firstly from said transmitting device,
wherein smaller-size packets are outputted lastly from said pre-transmission buffer and are transmitted lastly from said transmitting device;
wherein the pre-transmission buffer is configured to output video packets therefrom, based on said particular sorting order that is descending packet size, in a non-LIFO and non-FIFO and non-random buffer output scheme.

27. The system according to claim 25,
wherein the pre-transmission sorting unit is configured to sort by packet-size the pre-transmission video packets that are buffered in said pre-transmission buffer, in accordance with said particular sorting order that is ascending packet size;
wherein smaller-size packets are outputted firstly from said pre-transmission buffer and are transmitted firstly from said transmitting device,
wherein larger-size packets are outputted lastly from said pre-transmission buffer and are transmitted lastly from said transmitting device;
wherein the pre-transmission buffer is configured to output video packets therefrom, based on said particular sorting order that is ascending packet size, in a non-LIFO and non-FIFO and non-random buffer output scheme.

28. The system according to claim 25,
wherein the recipient device comprises a bandwidth estimation unit,
configured to estimate an available bandwidth of a communication channel between the transmitting device and the recipient device,
and configured to ignore, for bandwidth estimation and not for video decoding, any incoming video packets having a packet-size that is smaller than B bytes, wherein B is a pre-defined threshold value;
wherein the bandwidth estimation unit of the recipient device is configured to perform estimation of said available bandwidth based exclusively on incoming video packets having a packet-size that is equal to or greater than B bytes;
wherein the bandwidth estimation unit is configured to modify a resulting value of said bandwidth estimation to compensate for an estimated effect on bandwidth of the incoming video packets that were ignored due to having packet-size smaller than B bytes.

29. A system comprising:
a receiving device comprising:
(a) a receiver configured to receive packetized video data from a transmitting device over one or more communication networks;
(b) a de-packetizing unit, configured to de-packetize the incoming packetized video data, and to generate decoded video;
(c) a bandwidth estimation unit,
configured to estimate an available bandwidth of a communication channel between the transmitting device and the recipient device,
and configured to ignore, for bandwidth estimation and not for video decoding, any incoming video packets having a packet-size that is smaller than B bytes, wherein B is a pre-defined threshold value; wherein the bandwidth estimation unit is configured to modify a resulting value of said bandwidth estimation to compensate for an estimated effect on bandwidth of the incoming video packets that were ignored due to having packet-size smaller than B bytes;
wherein the bandwidth estimation unit performs estimation of said available bandwidth based exclusively on incoming video packets having a packet-size that is equal to or greater than B bytes.

30. The system of claim 29,
wherein the bandwidth estimation unit comprises:
(I) a first bandwidth estimation module, configured to estimate said available bandwidth by utilizing a first bandwidth estimation process, and to generate a first bandwidth estimation value;
(II) a second bandwidth estimation module, configured to estimate said available bandwidth by utilizing a second, different, bandwidth estimation process, and to generate a second bandwidth estimation value;
(III) a bandwidth estimation selector unit,
configured to select and to utilize one of: the first bandwidth estimation value, and the second bandwidth estimation value,
based on one or more pre-defined selection rules.
